(19) United States
(12) Patent Application Publication
(10) Pub. No.: US 2026/0259460 A1
(43) Pub. Date: Sep. 3, 2026

(54) Display Panel and Display Apparatus

(71) Applicants: BOE TECHNOLOGY GROUP CO., LTD., Chaoyang District, Beijing (CN); Fuzhou BOE Optoelectronics Technology Co., Ltd., Fuzhou, Fujian (CN); BEIJING BOE TECHNOLOGY DEVELOPMENT CO., LTD., Beijing (CN)

(72) Inventors: Jinliang Wang, Beijing (CN); Wenchao Wang, Beijing (CN); Sangjin Park, Beijing (CN); Xin Fang, Beijing (CN); Xiaolong Chen, Beijing (CN); Longgan Hu, Beijing (CN)

(21) Appl. No.: 18/993,740

(22) PCT Filed: May 14, 2024
(86) PCT No.: PCT/CN2024/093230

§ 371 Date: Jan. 13, 2025

(30) Foreign Application Priority Data
Jun. 29, 2023 (CN) 202310786841.9

(51) Int. Cl. G02F 1/1362; G02F 1/1368

(52) U.S. Cl. CPC G02F 1/136286; G02F 1/136209; G02F 1/1368

(57) ABSTRACT

A display panel includes a display region and a peripheral region surrounding the display region, and the peripheral region includes a first region, a second region, a third region and a fourth region; and the second region includes a bonding region. The display panel includes a light-sensing unit and bonding electrodes. The light-sensing unit includes a light-shielding unit and a light leakage unity; the light-shielding unit includes light-shielding transistors, and the light leakage unit includes light leakage transistors; and the light-sensing unit is arranged in at least one of the first region, the second region, the third region and the fourth region. The bonding electrodes are disposed in the bonding region of the display panel, and the bonding electrodes are configured to be connected to a dimming chip.

### CROSS-REFERENCE TO RELATED APPLICATIONS

This application is the United States national phase of International Patent Application No. PCT/CN2024/093230, filed May 14, 2024, and claims priority to Chinese Patent Application No. 202310786841.9, filed Jun. 29, 2023, the disclosures of which are hereby incorporated by reference in entireties.

### BACKGROUND OF THE INVENTION

### Field of the Invention

The present disclosure relates to the field of display technologies, and in particular, to a display panel and a display apparatus.

### Description of Related Art

With the development of display technologies and the improvement of energy consumption standards in the industry, the functional requirements for display screens are increasing, such as a light-sensing detection function. How to apply the light-sensing detection function to display screens and reduce the power consumption of the display screens without affecting the display effect has become one of the current research hotspots.

### SUMMARY OF THE INVENTION

In an aspect, a display panel is provided. The display panel includes a display region and a peripheral region surrounding the display region; the peripheral region includes a first region, a second region, a third region and a fourth region, the first region and the second region are located on both sides of the display region along a first direction, and the third region and the fourth region are located on both sides of the display region along a second direction. The first direction is perpendicular to the second direction. The second region includes a bonding region. The display panel includes a light-sensing unit and a plurality of bonding electrodes. The light-sensing unit is disposed in the peripheral region of the display panel. The light-sensing unit includes a light-shielding unit and a light leakage unit; the light-shielding unit includes a plurality of light-shielding transistors, and the light leakage unit includes a plurality of light leakage transistors. The light-sensing unit is arranged in at least one of the first region, the second region, the third region and the fourth region. The plurality of bonding electrodes are disposed in the bonding region of the display panel. The plurality of bonding electrodes are configured to be connected to a dimming chip, and the plurality of bonding electrodes include a first electrode, a second electrode, a third electrode and a fourth electrode. Control electrodes of the plurality of light-shielding transistors are electrically connected in sequence and electrically connected to the first electrode, first electrodes of the plurality of light-shielding transistors are electrically connected in sequence and electrically connected to the second electrode, and second electrodes of the plurality of light-shielding transistors are electrically connected in sequence and electrically connected to the third electrode. Control electrodes of the plurality of light leakage transistors are electrically connected in sequence and electrically connected to the first electrode, first electrodes of the plurality of light leakage transistors are electrically connected in sequence and electrically connected to the second electrode, and second electrodes of the plurality of light leakage transistors are electrically connected in sequence and electrically connected to the fourth electrode.

In some embodiments, the light-sensing unit further includes a dummy unit, and the dummy unit includes a plurality of dummy transistors. The plurality of light-shielding transistors are arranged along a same direction, the plurality of light leakage transistors are arranged along a same direction, and at least part of the plurality of dummy transistors are arranged along a same direction. The at least part of the dummy transistors are arranged along the same direction as the plurality of light-shielding transistors and/or the plurality of light leakage transistors. The plurality of bonding electrodes further include a plurality of dummy electrodes, and the plurality of bonding electrodes are arranged at intervals along the second direction.

In some embodiments, the light-sensing unit is located in the second region. The plurality of light-shielding transistors are arranged along the second direction, the plurality of light leakage transistors are arranged along the second direction, and the plurality of dummy transistors are arranged along the second direction. The light-shielding unit, the dummy unit and the light leakage unit are arranged along the second direction, and the dummy unit is located between the light-shielding unit and the light leakage unit.

In some embodiments, the display panel further includes multiple groups of fan-out wires between the display region and the bonding region, an interval region is provided between any two adjacent groups of fan-out wires in the multiple groups of fan-out wires, and interval regions include a first interval region, a second interval region and a third interval region. The light-shielding unit is located in the first interval region, the light leakage unit is located in the second interval region, and the dummy unit is located in the third interval region.

In some embodiments, the first electrode includes a first sub-electrode and a second sub-electrode, and the second electrode includes a third sub-electrode and a fourth sub-electrode. The control electrodes of the plurality of light-shielding transistors are electrically connected in sequence through a first gate line, and the first gate line is electrically connected to the first sub-electrode; the first electrodes of the plurality of light-shielding transistors are electrically connected in sequence through a first drain line, and the first drain line is electrically connected to the third sub-electrode. The control electrodes of the plurality of light leakage transistors are electrically connected in sequence through a second gate line, and the second gate line is electrically connected to the second sub-electrode; the first electrodes of the plurality of light leakage transistors are electrically connected in sequence through a second drain line, and the second drain line is electrically connected to the fourth sub-electrode.

In some embodiments, control electrodes of the plurality of dummy transistors are electrically connected in sequence through a dummy gate line, and the dummy gate line is electrically connected to a dummy electrode; second electrodes of the plurality of dummy transistors are electrically connected in sequence through a dummy source line, and the dummy source line is electrically connected to a dummy electrode; first electrodes of the plurality of dummy transistors are electrically connected in sequence through a dummy drain line, and the dummy drain line is electrically connected to a dummy electrode.

In some embodiments, the light-sensing unit is located in the first region. The plurality of light-shielding transistors are arranged along the second direction, the plurality of light leakage transistors are arranged along the second direction, and the plurality of dummy transistors are arranged along the second direction. The light-shielding unit, the dummy unit and the light leakage unit are arranged along the second direction, and the dummy unit is located between the light-shielding unit and the light leakage unit.

In some embodiments, the control electrodes of the plurality of light-shielding transistors and the control electrodes of the plurality of light leakage transistors are electrically connected in sequence through a gate signal line, and the gate signal line is electrically connected to the first electrode. The first electrodes of the plurality of light-shielding transistors and the first electrodes of the plurality of light leakage transistors are electrically connected in sequence through a drain signal line, and the drain signal line is electrically connected to the second electrode.

In some embodiments, control electrodes of the plurality of dummy transistors are electrically connected in sequence, and first electrodes or second electrodes of the plurality of dummy transistors are electrically connected in sequence.

In some embodiments, the light-shielding unit is located in the third region, and the light leakage unit is located in the fourth region. The plurality of dummy transistors in the dummy unit include a plurality of first dummy transistors and a plurality of second dummy transistors, the plurality of first dummy transistors are located in the third region, and the plurality of second dummy transistors are located in the fourth region. The plurality of light-shielding transistors are arranged along the first direction, the plurality of light leakage transistors are arranged along the first direction, the plurality of first dummy transistors are arranged along the first direction, and the plurality of second dummy transistors are arranged along the first direction. The light-shielding unit and the plurality of first dummy transistors are arranged along the first direction, and the light leakage unit and the plurality of second dummy transistors are arranged along the first direction.

In some embodiments, the first electrode includes a first sub-electrode and a second sub-electrode, and the second electrode includes a third sub-electrode and a fourth sub-electrode. The control electrodes of the plurality of light-shielding transistors are electrically connected in sequence through a first gate line, and the first gate line is electrically connected to the first sub-electrode. The first electrodes of the plurality of light-shielding transistors are electrically connected in sequence through a first drain line, and the first drain line is electrically connected to the third sub-electrode. The control electrodes of the plurality of light leakage transistors are electrically connected in sequence through a second gate line, and the second gate line is electrically connected to the second sub-electrode. The first electrodes of the plurality of light leakage transistors are electrically connected in sequence through a second drain line, and the second drain line is electrically connected to the fourth sub-electrode.

In some embodiments, control electrodes of the plurality of first dummy transistors are electrically connected in sequence, second electrodes of the plurality of first dummy transistors are electrically connected in sequence, and first electrodes of the plurality of first dummy transistors are electrically connected in sequence. Control electrodes of the plurality of second dummy transistors are electrically connected in sequence, second electrodes of the plurality of second dummy transistors are electrically connected in sequence, and first electrodes of the plurality of second dummy transistors are electrically connected in sequence.

In some embodiments, the plurality of first dummy transistors are away from the plurality of bonding electrodes relative to the plurality of light-shielding transistors, and the plurality of second dummy transistors are away from the plurality of bonding electrodes relative to the plurality of light leakage transistors.

In some embodiments, the second electrodes of the plurality of light-shielding transistors are all electrically connected to a first source line, there is at least one first cutting position on the first source line, and a first cutting position is located between second electrodes of any two adjacent light-shielding transistors; and/or the second electrodes of the plurality of light leakage transistors are all electrically connected to a second source line, there is at least one second cutting position on the second source line, and a second cutting position is located between second electrodes of any two adjacent light leakage transistors.

In some embodiments, the light-sensing unit is located in the first region. Control electrodes of the plurality of dummy transistors are electrically connected to the control electrodes of the plurality of light-shielding transistors and the control electrodes of the plurality of light leakage transistors. First electrodes of the plurality of dummy transistors are electrically connected in sequence, and are electrically connected to the first electrodes of the plurality of light-shielding transistors and the first electrodes of the plurality of light leakage transistors. Second electrodes of the plurality of dummy transistors are all electrically connected to a dummy source line. There is a first welding position between the first source line and the dummy source line, and the first source line and the dummy source line are enabled to be welded at the first welding position; and/or there is a second welding position between the second source line and the dummy source line, and the second source line and the dummy source line are enabled to be welded at the second welding position.

In some embodiments, the dummy source line includes at least two dummy source sub-lines that are disconnected, and each dummy source sub-line is electrically connected to a second electrode of at least one dummy transistor in the plurality of dummy transistors. There is a third welding position between two adjacent dummy source sub-lines, and the two adjacent dummy source sub-lines are enabled to be welded at the third welding position.

In some embodiments, the light-shielding unit is located in the third region, and the light leakage unit is located in the fourth region. Control electrodes of the plurality of first dummy transistors and the control electrodes of the plurality of light-shielding transistors are electrically connected, and first electrodes of the plurality of first dummy transistors and the first electrodes of the plurality of light-shielding transistors are electrically connected; second electrodes of the plurality of first dummy transistors are all electrically connected to a light-shielding dummy source line; there is a fourth welding position between the first source line and the light-shielding dummy source line, and the first source line and the light-shielding dummy source line are enabled to be welded at the fourth welding position. And/or, control electrodes of the plurality of second dummy transistors and the control electrodes of the plurality of light leakage transistors are electrically connected, and first electrodes of the plurality of second dummy transistors and the first electrodes of the plurality of light leakage transistors are electrically connected; second electrodes of the plurality of second dummy transistors are all electrically connected to a light leakage dummy source line; there is a fifth welding position between the second source line and the light leakage dummy source line, and the second source line and the light leakage dummy source line are enabled to be welded at the fifth welding position.

In some embodiments, the light-shielding dummy source line includes at least two light-shielding dummy source sub-lines that are disconnected, and each light-shielding dummy source sub-line is electrically connected to at least one first dummy transistor; there is a sixth welding position between two adjacent light-shielding dummy source sub-lines, and the two adjacent light-shielding dummy source sub-lines are enabled to be welded at the sixth welding position. And/or, the light leakage dummy source line includes at least two light leakage dummy source sub-lines that are disconnected, and each light leakage dummy source sub-line is electrically connected to at least one second dummy transistor; there is a seventh welding position between two adjacent light leakage dummy source sub-lines, and the two adjacent light leakage dummy source sub-lines are enabled to be welded at the seventh welding position.

In some embodiments, the display panel further includes: a base substrate; a gate layer disposed on the base substrate, the gate layer including a first connection line; an insulating layer disposed on a side of the gate layer away from the base substrate; an active layer disposed on a side of the insulating layer away from the base substrate; a metal layer disposed on a side of the active layer away from the base substrate, the metal layer including first and second electrodes of transistors and a plurality of signal lines, and the plurality of signal lines include: the first source line, the second source line, the dummy source line, the light-shielding dummy source line, and the light leakage dummy source line; a passivation layer disposed on a side of the metal layer away from the base substrate; and a connection layer disposed on a side of the passivation layer away from the base substrate, the connection layer including a second connection line. Two signal lines that need to be welded are a first signal line and a second signal line. The second connection line is electrically connected to the first signal line through a first via hole penetrating through the passivation layer, and the second connection line is electrically connected to the first connection line through a second via hole penetrating through the passivation layer and the insulating layer. The first connection line at least partially overlaps with the second signal line, and an overlapping position of the two is a welding position. The welding position includes the first welding position, the second welding position, the third welding position, the fourth welding position, the fifth welding position, the sixth welding position, or the seventh welding position.

In some embodiments, the display panel includes a base substrate, and further includes a light-shielding layer disposed on a side of the light-sensing unit away from the base substrate. The light-shielding layer is provided therein with a plurality of openings that are arranged at intervals, and each of the plurality of openings exposes a light leakage transistor in the plurality of light leakage transistors.

In some embodiments, the light leakage transistor includes an active layer pattern, the active layer pattern includes a channel portion, and an orthographic projection of the channel portion on the base substrate is located in a middle position of an orthographic projection of the opening on the base substrate.

In some embodiments, in a third direction, a distance between a border of the orthographic projection of the channel portion and a border, on a same side as the border of the orthographic projection of the channel portion, of the orthographic projection of the opening is a first distance, and the first distance is in a range of 5 μm to 6 μm. In a fourth direction, a distance between a border of the orthographic projection of the channel portion and a border, on a same side as the border of the orthographic projection of the channel portion, of the orthographic projection of the opening is a second distance, and the second distance is in a range of 5 μm to 6 μm. The fourth direction is a direction pointing from a second electrode to a first electrode of the light leakage transistor, and the third direction is perpendicular to the fourth direction.

In some embodiments, the light-shielding layer further includes at least one light-shielding strip disposed in the opening, and the at least one light-shielding strip at least partially overlaps with a second electrode and a first electrode of the light leakage transistor.

In some embodiments, the light-shielding layer includes at least two light-shielding strips, and the at least two light-shielding strips are arranged in parallel.

In some embodiments, the light-shielding layer includes at least two light-shielding strips. Widths of the at least two light-shielding strips are all a first width. A distance between two adjacent light-shielding strips, a distance between a light-shielding strip close to a first border of the opening and the first border of the opening, and a distance between a light-shielding strip close to a second border of the opening and the second border of the opening are all a first distance. The first border and the second border are opposite borders of the opening.

In some embodiments, the plurality of openings include at least one dummy opening, and the at least one dummy opening exposes at least one dummy transistor, adjacent to the light leakage transistor, among the plurality of dummy transistors.

In some embodiments, transistors included in the light-sensing unit are oxide transistors.

In another aspect, a display apparatus is provided. The display apparatus includes: the display panel as described in any one of the above embodiments, a backlight module disposed on a side of the display panel, and a dimming chip electrically connected to the display panel and the backlight module. The dimming chip is configured to receive a first current generated by the light-shielding unit and a second current generated by the light leakage unit, and adjust brightness of light exiting from the backlight module according to the first current and the second current.

### BRIEF DESCRIPTION OF THE DRAWINGS

In order to describe technical solutions in the present disclosure more clearly, the accompanying drawings to be used in some embodiments of the present disclosure will be introduced briefly. Obviously, the accompanying drawings to be described below are merely drawings of some embodiments of the present disclosure, and a person of ordinary skill in the art can obtain other drawings according to those drawings. In addition, the accompanying drawings in the following description can be regarded as schematic diagrams, but are not limitations on actual sizes of products, actual processes of methods and actual timings of signals involved in the embodiments of the present disclosure.

FIG. 1 is a structural diagram of a display panel, in accordance with some embodiments;

FIG. 2A is a structural diagram of another display panel, in accordance with some embodiments;

FIG. 2B is a structural diagram of yet another display panel, in accordance with some embodiments;

FIG. 2C is a structural diagram of yet another display panel, in accordance with some embodiments;

FIG. 3 is a diagram showing a connection structure of a light-sensing unit of a display panel, in accordance with some embodiments;

FIG. 4A is a diagram showing another connection structure of a light-sensing unit of a display panel, in accordance with some embodiments;

FIG. 4B is a diagram showing yet another connection structure of a light-sensing unit of a display panel, in accordance with some embodiments;

FIG. 5 is a diagram showing yet another connection structure of a light-sensing unit of a display panel, in accordance with some embodiments;

FIG. 6 is a diagram showing yet another connection structure of a light-sensing unit of a display panel, in accordance with some embodiments;

FIG. 7 is a structural diagram of a light-shielding unit of a display panel, in accordance with some embodiments;

FIG. 8 is a structural diagram of a light leakage unit of a display panel, in accordance with some embodiments;

FIG. 9 is a structural diagram of a light-sensing unit of a display panel, in accordance with some embodiments;

FIG. 10A is a diagram showing a welding structure of a light-sensing unit of a display panel, in accordance with some embodiments;

FIG. 10B is a diagram showing another welding structure of a light-sensing unit of a display panel, in accordance with some embodiments;

FIG. 10C is a diagram showing yet another welding structure of a light-sensing unit of a display panel, in accordance with some embodiments;

FIG. 10D is a diagram showing yet another welding structure of a light-sensing unit of a display panel, in accordance with some embodiments;

FIG. 11A is a diagram showing yet another welding structure of a light-sensing unit of a display panel, in accordance with some embodiments;

FIG. 11B is a diagram showing yet another welding structure of a light-sensing unit of a display panel, in accordance with some embodiments;

FIG. 11C is a diagram showing yet another welding structure of a light-sensing unit of a display panel, in accordance with some embodiments;

FIG. 12A is a diagram showing yet another welding structure of a light-sensing unit of a display panel, in accordance with some embodiments;

FIG. 12B is a diagram showing yet another welding structure of a light-sensing unit of a display panel, in accordance with some embodiments;

FIG. 12C is a diagram showing yet another welding structure of a light-sensing unit of a display panel, in accordance with some embodiments;

FIG. 13A is a diagram showing a welding structure of a light-sensing unit of a display panel, in accordance with some embodiments;

FIG. 13B is a sectional structural diagram obtained by making a cross section taken along the section line FF′ in FIG. 13A;

FIG. 13C is another sectional structural diagram obtained by making a cross section taken along the section line FF′ in FIG. 13A;

FIG. 14 is a structural diagram of a light-shielding layer of a display panel, in accordance with some embodiments;

FIG. 15 is a partial enlarged structural diagram of the region A in FIG. 14;

FIG. 16 is a structural diagram of another light-shielding layer of a display panel, in accordance with some embodiments;

FIG. 17 is a structural diagram of yet another light-shielding layer of a display panel, in accordance with some embodiments; and

FIG. 18 is a structural diagram of a display apparatus, in accordance with some embodiments.

### DESCRIPTION OF THE INVENTION

The technical solutions in some embodiments of the present disclosure will be described clearly and completely with reference to the accompanying drawings. Obviously, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to”. In the description of the specification, the terms such as “one embodiment”, “some embodiments”, “exemplary embodiments”, “example”, “specific example”, or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

The terms “first” and “second” are used for descriptive purposes only, and are not to be construed as indicating or implying a relative importance or implicitly indicating the number of indicated technical features. Thus, a feature defined with “first” or “second” may explicitly or implicitly include one or more of the features. In the description of the embodiments of the present disclosure, the term “a/the plurality of” means two or more unless otherwise specified.

In the description of some embodiments, the expressions “coupled”, “connected”, and derivatives thereof can be used. The term “connected” should be understood in a broad sense. For example, the term “connected” may represent a fixed connection, a detachable connection, or a one-piece connection, or may represent a direct connection, or may represent an indirect connection through an intermediate medium. The term “coupled” indicates, for example, that two or more components are in direct physical or electrical contact. The term “coupled” or “communicatively coupled” may also mean that two or more components are not in direct contact with each other but still cooperate or interact with each other. The embodiments disclosed herein are not necessarily limited to the content herein.

The phrase “at least one of A, B, and C” has the same meaning as the phrase “at least one of A, B, or C”, and they both include the following combinations of A, B, and C: only A, only B, only C, a combination of A and B, a combination of A and C, a combination of B and C, and a combination of A, B, and C.

The phrase “A and/or B” includes following three combinations: only A, only B, and a combination of A and B.

As used herein, the term “if” is, optionally, construed as “when” or “in a case where” or “in response to determining” or “in response to detecting”, depending on the context. Similarly, depending on the context, the phrase “if it is determined that” or “if [a stated condition or event] is detected” is optionally construed as “in a case where it is determined that” or “in response to determining that” or “in a case where [the stated condition or event] is detected” or “in response to detecting [the stated condition or event]”.

The phrase “applicable to” or “configured to” used herein means an open and inclusive expression, which does not exclude devices that are applicable to or configured to perform additional tasks or steps.

In addition, the phase “based on” used herein is meant to be open and inclusive, since a process, step, calculation or other action that is “based on” one or more of the stated conditions or values may, in practice, be based on an additional condition or value beyond those stated.

The term such as “about”, “substantially”, or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

The term such as “parallel”, “perpendicular”, or “equal” as used herein includes a stated condition and a condition similar to the stated condition. A range of the similar condition is within an acceptable range of deviation, and the acceptable range of deviation is determined by a person of ordinary skill in the art, considering measurement in question and errors associated with measurement of a particular quantity (i.e., the limitations of a measurement system). For example, the term “parallel” includes absolute parallelism and approximate parallelism, and an acceptable range of deviation of the approximate parallelism may be a deviation within 5°; and the term “perpendicular” includes absolute perpendicularity and approximate perpendicularity, and an acceptable range of deviation of the approximate perpendicularity may also be a deviation within 5°. The term “equal” includes absolute equality and approximate equality, and an acceptable range of deviation of the approximate equality may be, for example, that a difference between two equals is less than or equal to 5% of either of the two equals.

It should be understood that, when a layer or element is referred to as being on another layer or substrate, it may be that the layer or element is directly on the another layer or substrate, or it may be that intervening layer(s) exist between the layer or element and the another layer or substrate.

Exemplary embodiments are described herein with reference to sectional views and/or plan views as idealized exemplary drawings. In the drawings, thicknesses of layers and sizes of regions are enlarged for clarity. Thus, variations in shape with respect to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown to have a rectangular shape generally has a curved feature. Therefore, the regions shown in the accompanying drawings are schematic in nature, and their shapes are not intended to show actual shapes of the regions in an apparatus, and are not intended to limit the scope of the exemplary embodiments.

At present, with the improvement of energy consumption standards, displays are developing towards low power consumption. In order to reduce the power consumption of displays, methods such as reducing the intra-screen load and increasing the transmittance of display panels are often used. In some embodiments, backlight brightness is adjusted to reduce the power consumption. That is, a light sensor that is capable of detecting brightness changes in ambient light is provided in a display panel, and brightness of the display screen is adjusted according to the brightness changes in ambient light through the detection of ambient light, thereby reducing the power consumption of the display screen. In the related art, the position of the light sensor is limited to a fixed position of the display panel, which is not conducive to the selective utilization of space.

Based on this, some embodiments of the present disclosure provide a display panel and a display apparatus to achieve automatic adjustment of brightness of the display panel according to the brightness changes in ambient light, thereby reducing the power consumption of the display panel and bringing good visual effects to users.

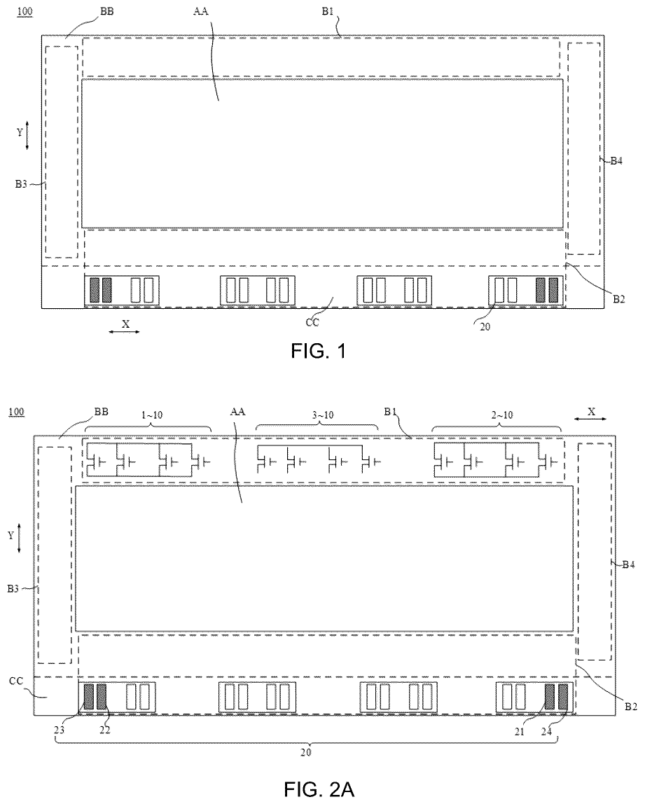

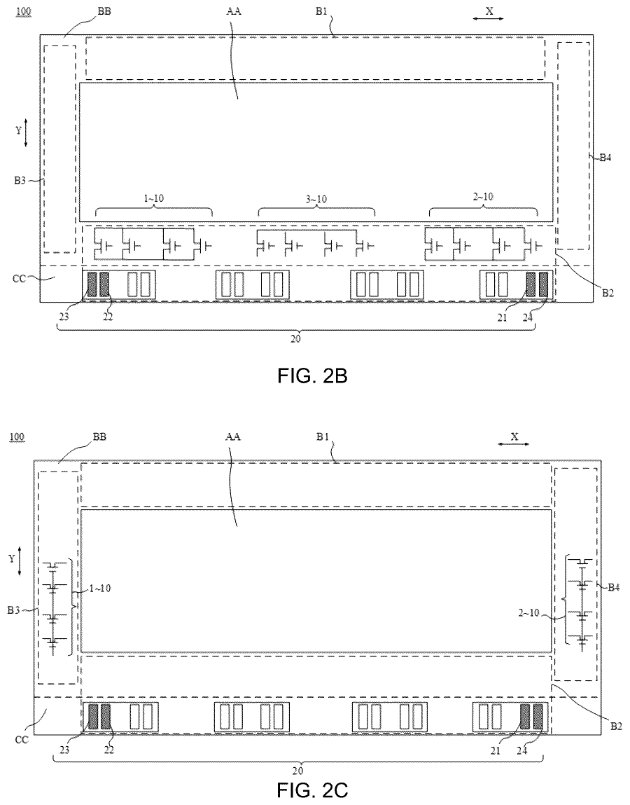

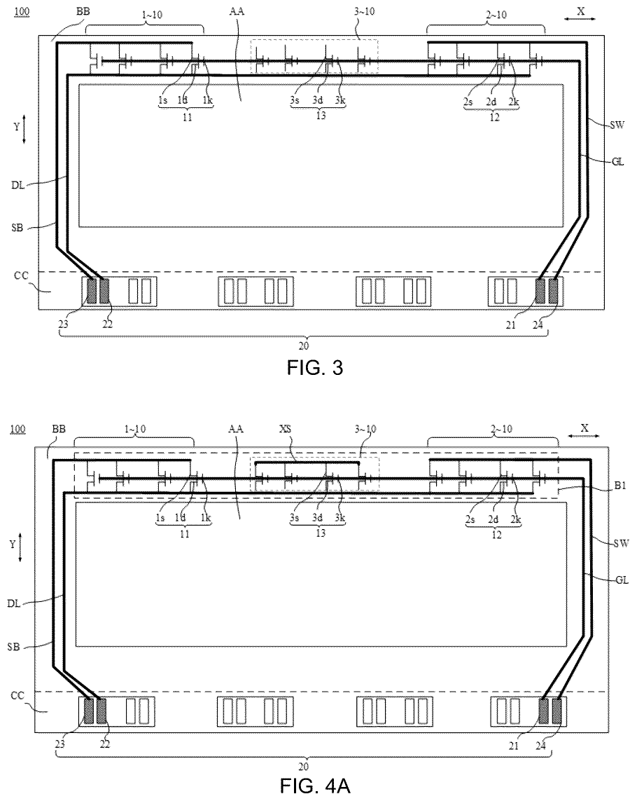

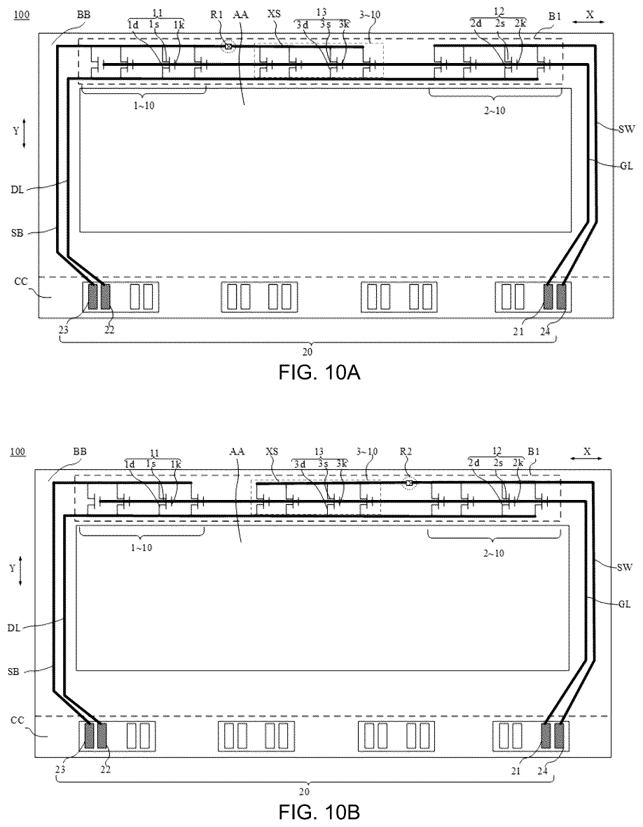

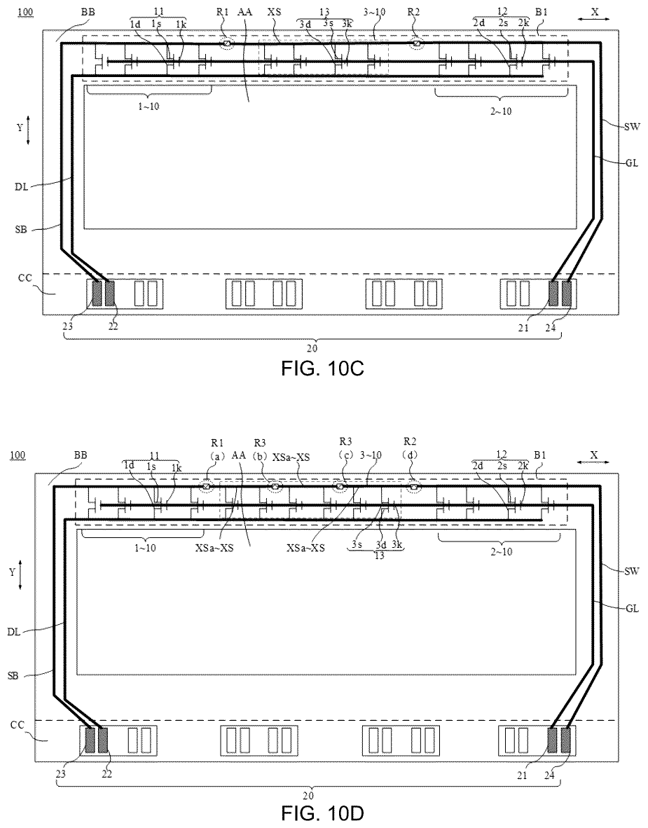

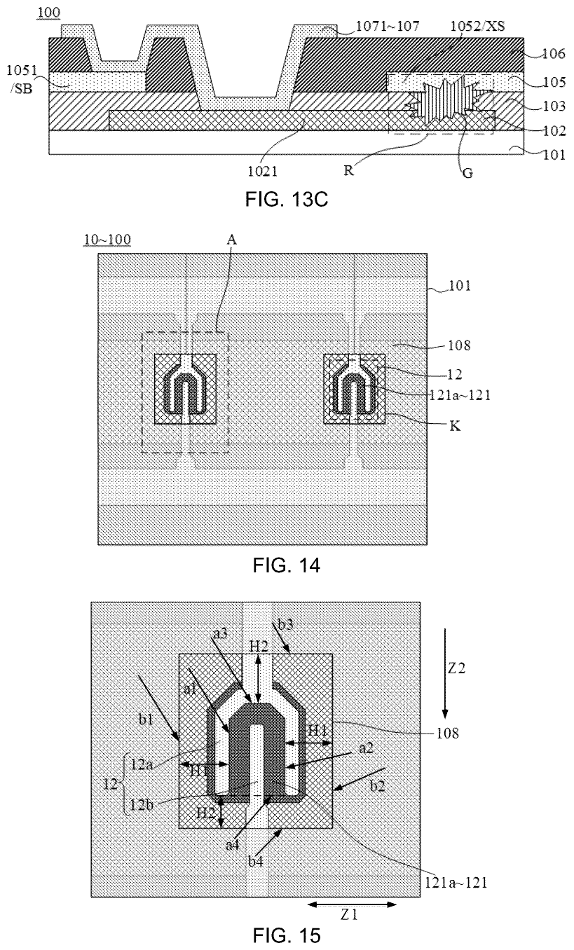

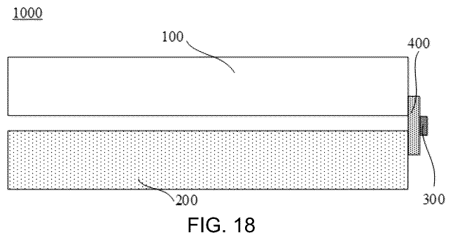

In the embodiments of the present disclosure, FIG. 1 is a structural diagram of a display panel according to some embodiments, and FIG. 1 only illustrates a region division of the display panel; and FIGS. 2A to 2C show specific arrangements of light-sensing units in display panels, but do not illustrate a connection relationship of the light-sensing unit in the display panel. In order to facilitate a clear description of a connection of a light-sensing unit, FIGS. 3 to 6 are diagrams showing connection structures of light-sensing units in display panels according to some embodiments, and show specific connections corresponding to the light-sensing units in different regions in some embodiments; FIGS. 7 to 9 show specific manners of providing cutting positions of light-sensing units in a light-shielding unit and a light leakage unit in some embodiments; FIGS. 10A to 12C are diagrams showing welding structures of welding positions of light-sensing units in display panels according to some embodiments; FIGS. 13A to 13C show a plan view and sectional views of a light-sensing unit in a display panel at a welding position in some embodiments; FIGS. 14 to 17 are structural diagrams of light-shielding layers in display panels according to some embodiments; and FIG. 18 is a structural diagram of a display apparatus 1000 according to some embodiments.

It should be noted that, for example, “1~10” shown in the accompanying drawings of the present disclosure indicates that the component 1 belongs to the component 10. For example, “1~10” indicates that the light-shielding unit 1 belongs to the light-sensing unit 10. Other similar signs shown in the accompanying drawings also follow the above description. For example, 1051/SB in the accompanying drawings of the present disclosure indicates that both the first signal line 1051 and the first source line SB can refer to the structure indicated by the sign, and other similar signs in the accompanying drawings also follow the above description.

As shown in FIG. 1, some embodiments of the present disclosure provide a display panel 100. The display panel 100 includes a display region AA and a peripheral region BB surrounding the display region. The peripheral region BB includes a first region B1, a second region B2, a third region B3 and a fourth region B4, the first region B1 and the second region B2 are located on both sides of the display region AA along a first direction Y, and the third region B3 and the fourth region B4 are located on both sides of the display region AA along a second direction X. The first direction Y is perpendicular to the second direction X. The second region B2 includes a bonding region CC.

It should be noted that, the display panel 100 includes a display surface and a non-display surface, the above descriptions of the display region AA and the peripheral region BB are all descriptions of the display surface of the display panel 100, and the first direction Y and the second direction X are both parallel to the display surface of the display panel 100.

As shown in FIGS. 2A to 2C, the display panel 100 includes a light-sensing unit 10 disposed in the peripheral region BB and a plurality of bonding electrodes 20 disposed in the bonding region CC. The light-sensing unit 10 includes a light-shielding unit 1 and a light leakage unit 2. The light-shielding unit 1 includes a plurality of light-shielding transistors 11, and the light leakage unit 2 includes a plurality of light leakage transistors 12. The light-sensing unit 10 is arranged in at least one of the first region B1, the second region B2, the third region B3 or the fourth region B4.

It can be understood that, the light-sensing unit 10 can be arranged in one of the first region B1, the second region B2, the third region B3 or the fourth region B4 (for example, the light-sensing unit is located in the first region B1); the light-sensing unit 10 can also be arranged in any two of the first region B1, the second region B2, the third region B3 and the fourth region B4 (for example, a portion of the light-sensing unit 10 is arranged in the first region B1, and the other portion of the light-sensing unit 10 is arranged in the third region B3). Similarly, the light-sensing unit 10 can also be arranged in any three of the first region B1, the second region B2, the third region B3 and the fourth region B4 (for example, a portion of the light-sensing unit 10 is arranged in the first region B1, another portion of the light-sensing unit 10 is arranged in the third region B3, and the other portion of the light-sensing unit 10 is arranged in the fourth region B4); the light-sensing unit 10 can also be arranged in the first region B1, the second region B2, the third region B3 and the fourth region B4 (for example, the light-sensing unit is divided into four portions, and the four portions are respectively arranged in the first region B1, the second region B2, the third region B3 and the fourth region B4).

For example, as shown in FIG. 2A, the light-sensing unit 10 is arranged in the first region B1; or as shown in FIG. 2B, the light-sensing unit 10 is located in the second region B2; or as shown in FIG. 2C, the light-shielding unit 1 and the light leakage unit 2 are respectively located in the third region B3 and the fourth region B4. The plurality of bonding electrodes 20 are configured to be connected to a dimming chip, and the plurality of bonding electrodes 20 include a first electrode 21, a second electrode 22, a third electrode 23 and a fourth electrode 24.

The light-sensing unit 10 described above can detect brightness changes in ambient light. By arranging the light-shielding unit 1 and the light leakage unit 2, the light leakage transistors 12 in the light leakage unit 2 are affected by light during an operation of the light leakage unit 2 and can generate a large light-sensing current, while the light-shielding transistors 11 in the light-shielding unit 1 are not affected by ambient light and can generate a dark current, which serves as a reference current; the light-sensing current and the reference current are respectively transmitted to corresponding bonding electrodes 20, and the current signals are transmitted to the dimming chip through the bonding electrodes 20; the dimming chip can detect ambient light according to the difference in the current signal, and then complete the adjustment of the brightness of the display panel according to the brightness change in ambient light.

The light-sensing unit 10 can be specifically arranged according to an actual spatial layout of the display panel 100. In some embodiments of the present disclosure, there is no limitation on the region where the light-sensing unit 10 is specifically located.

It should be noted that the first electrode 21, the second electrode 22, the third electrode 23 and the fourth electrode 24 in the plurality of bonding electrodes 20 are all electrically connected to the dimming chip. The light-sensing unit 10 transmits different electrical signals to the bonding electrodes 20 connected to the dimming chip, and the electrical signals are transmitted to the dimming chip through the bonding electrodes 20. The dimming chip analyzes changes in the electrical signals with ambient light through simulation calculation, and thereby realizes the adjustment of the brightness of the display panel 100.

In some embodiments, referring to FIGS. 3, 5 and 6, control electrodes 1k of the plurality of light-shielding transistors 11 are electrically connected in sequence and electrically connected to the first electrode 21, first electrodes 1d of the plurality of light-shielding transistors 11 are electrically connected in sequence and electrically connected to the second electrode 22, and second electrodes 1s of the plurality of light-shielding transistors 11 are electrically connected in sequence and electrically connected to the third electrode 23. Control electrodes 2k of the plurality of light leakage transistors 12 are electrically connected in sequence and electrically connected to the first electrode 21, first electrodes 2d of the plurality of light leakage transistors 12 are electrically connected in sequence and electrically connected to the second electrode 22, and second electrodes 2s of the plurality of light leakage transistors 12 are electrically connected in sequence and electrically connected to the fourth electrode 24.

It should be noted that, as shown in FIG. 3, the control electrodes 1k of the plurality of light-shielding transistors 11 are all electrically connected to a gate signal line GL, the gate signal line GL is electrically connected to the first electrode 21, and the plurality of light-shielding transistors 11 receive a gate signal provided by the first electrode 21; the first electrodes 1d of the plurality of light-shielding transistors 11 are all connected to a drain signal line DL, the drain signal line DL is electrically connected to the second electrode 22, and the plurality of light-shielding transistors 11 receive a drain signal provided by the second electrode 22; the second electrodes 1s of the plurality of light-shielding transistors 11 are all electrically connected to a first source line SB, the first source line SB is electrically connected to the third electrode 23, and the plurality of light-shielding transistors 11 transmit a generated dark current to the third electrode 23 through the first source line SB.

The control electrodes 2k of the plurality of light leakage transistors 12 are all electrically connected to a gate signal line GL, the gate signal line GL is electrically connected to the first electrode 21, and the plurality of light leakage transistors 12 receive a gate signal provided by the first electrode 21; the first electrodes 2d of the plurality of light leakage transistors 12 are all electrically connected to a drain signal line DL, the drain signal line DL is electrically connected to the second electrode 22, and the plurality of light leakage transistors 12 receive a drain signal provided by the second electrode 22; the second electrodes 2s of the plurality of light leakage transistors 12 are all electrically connected to a second source line SW, the second source line SW is electrically connected to the fourth electrode 24, and the plurality of light leakage transistors 12 transmit a generated light-sensing current to the fourth electrode 24.

In the embodiments of the present disclosure, the position of the light-sensing unit 10 in the display panel is flexible, and the light-sensing unit 10 can be arranged in any one of the first region B1, the second region B2, the third region B3 and the fourth region B4 in the peripheral region BB of the display panel. Moreover, there is a corresponding scheme for connecting the light-sensing unit 10 to the bonding electrodes 20. Thus, the arrangement position of the light-sensing unit 10 may be reasonably selected according to the spatial layout of the display panel 100, thereby improving the space utilization of the display panel 100 and enhancing the practicality.

In some embodiments, referring to FIG. 3, the light-sensing unit 10 further includes a dummy unit 3, and the dummy unit 3 includes a plurality of dummy transistors 13. The plurality of light-shielding transistors 11 are arranged along the same direction, the plurality of light leakage transistors 12 are arranged along the same direction, and at least part of the plurality of dummy transistors 13 are arranged along the same direction. The at least part of the dummy transistors 13 are arranged along the same direction as the plurality of light-shielding transistors 11 and/or the plurality of light leakage transistors 12. The plurality of bonding electrodes 20 are arranged at intervals along the second direction X.

It can be understood that, the at least part of the plurality of dummy transistors 13 are arranged along the same direction, which means that a part of the plurality of dummy transistors 13 are arranged along the same direction, and another part of the plurality of dummy transistors 13 are arranged along another direction, or that all of the plurality of dummy transistors 13 are arranged along the same direction.

The at least part of the dummy transistors 13 are arranged along the same direction as the plurality of light-shielding transistors 11 and/or the plurality of light leakage transistors 12, which includes the following multiple examples. For example, the plurality of light-shielding transistors 11 and some of the dummy transistors 13 are arranged along the same direction; or the plurality of light leakage transistors 12 and some of the dummy transistors 13 are arranged along the same direction; or the plurality of light-shielding transistors 11 and the plurality of dummy transistors 13 are arranged along the same direction, or the plurality of light leakage transistors 12 and the plurality of dummy transistors 13 are arranged along the same direction; or the plurality of light-shielding transistors 11, the plurality of light leakage transistors 12 and some of the dummy transistors 13 are arranged along the same direction; or the plurality of light-shielding transistors 11, the plurality of light leakage transistors 12 and the plurality of dummy transistors 13 are arranged along the same direction.

Here, the same direction can be the first direction Y or the second direction X, and the plurality of dummy transistors 13 can be arranged between the plurality of light-shielding transistors 11 and the plurality of light leakage transistors 12, or can be arranged on a side of the plurality of light-shielding transistors 11 and the plurality of light leakage transistors 12 away from the bonding electrodes 20.

For example, a distance between two adjacent light-shielding transistors in the plurality of light-shielding transistors 11 along their arrangement direction is equal; a distance between two adjacent light leakage transistors 12 in the plurality of light leakage transistors 12 along their arrangement direction is equal; and a distance between two adjacent dummy transistors 13 in the plurality of dummy transistors 13 along their arrangement direction is equal. Furthermore, a distance between any two adjacent transistors in the plurality of dummy transistors 13, the plurality of light-shielding transistors 11 and the plurality of light leakage transistors 12 along their arrangement direction is equal, so that the plurality of transistors are evenly arranged and arranged in a regular manner.

For example, a film layer structure of each transistor is consistent, and each transistor includes a gate pattern, an active layer pattern, a source pattern and a drain pattern. Each of the patterns of the dummy transistor 13 and a respective one of the patterns of the light-shielding transistor 11 and/or the light leakage transistor 12 are arranged in the same layer and have the same shape. For example, the gate pattern of the dummy transistor 13 and the gate pattern of the light-shielding transistor 11 are located in the same layer and have the same shape. Thus, it further ensures that the film layer environment of transistors is consistent.

In a manufacturing process of the display panel 100, a rubbing process is often used. Due to the limitation on the number of the plurality of light-sensing transistors (light leakage transistors) and the plurality of light-shielding transistors in the light-sensing unit 10, the plurality of light-sensing transistors (light leakage transistors) and the plurality of light-shielding transistors 11 cannot fully occupy one region in the peripheral region along their arrangement direction (for example, the light-sensing unit cannot fully occupy the first region), resulting in uneven arrangement of transistors in the light-sensing unit (light leakage unit). Thus, the film layer environments at different positions are different, there will be a rubbing risk, and moiré fringes will appear. The dummy unit 3 is arranged in the light-sensing unit 10, the arrangement of the dummy transistors 13 in the dummy unit 3 is consistent with the arrangement of the light-shielding transistors 11 and the arrangement of the light leakage transistors 12, and each of the patterns of the dummy transistor 13 and a respective one of the patterns of the light-shielding transistor 11 and/or the light leakage transistor 12 are arranged in the same layer and have the same shape (that is, the film layer environments of the transistors in the light-sensing unit 10 are consistent), so that the occurrence of moiré fringes generated in the rubbing process in the manufacturing process of the display product may be reduced, thereby ensuring the uniformity of brightness and chromaticity of the display product.

The following specifically describes the spatial layout of the plurality of dummy transistors 13, the plurality of light-shielding transistors 11 and the plurality of light leakage transistors 12 in the light-sensing unit 10 in the display panel 100, and the specific connections between the bonding electrodes 20 and the plurality of dummy transistors 13, the plurality of light-shielding transistors 11 and the plurality of light leakage transistors 12 in the light-sensing unit 10.

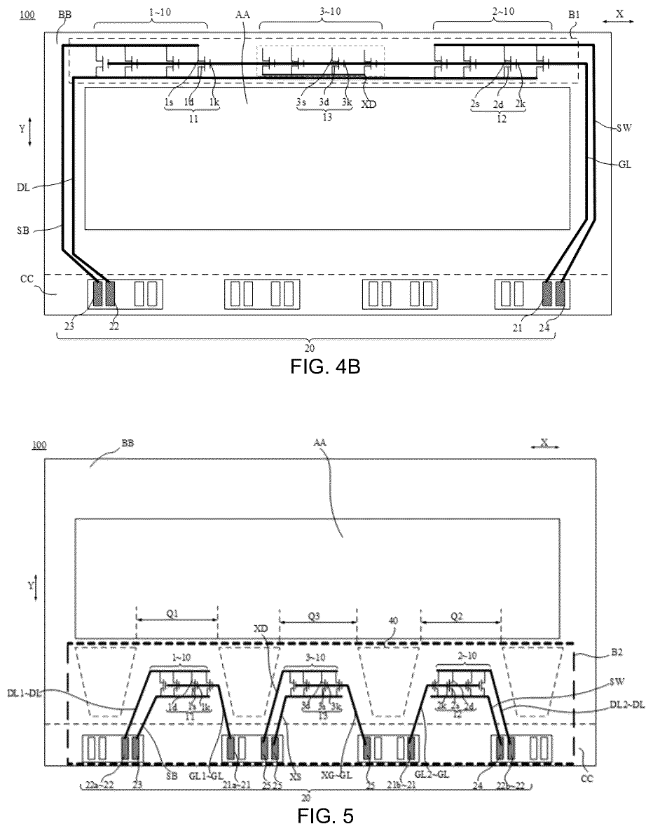

In some embodiments, referring to FIGS. 3, 4A and 4B, the light-sensing unit 10 is located in the first region B1; the plurality of light-shielding transistors 11 are arranged along the second direction X, the plurality of light leakage transistors 12 are arranged along the second direction X, and the plurality of dummy transistors 13 are arranged along the second direction X. The light-sensing unit 10 includes the light-shielding unit 1, the light leakage unit 2 and the dummy unit 3, and the light-shielding unit 1, the dummy unit 3 and the light leakage unit 2 are arranged along the second direction X; and the dummy unit 3 is arranged between the light-shielding unit 1 and the light leakage unit 2. The control electrodes 1k of the plurality of light-shielding transistors 11, the control electrodes 3k of the plurality of dummy transistors 13, and the control electrodes 2k of the plurality of light leakage transistors 12 are electrically connected in sequence through a gate signal line GL, and the gate signal line GL is electrically connected to the first electrode 21. The first electrodes 1d of the plurality of light-shielding transistors 11 and the first electrodes 2d of the plurality of light leakage transistors 12 are electrically connected in sequence through a drain signal line DL, and the drain signal line DL is electrically connected to the second electrode 22. The second electrodes 1s of the plurality of light-shielding transistors 11 are all electrically connected to a first source line SB, and the first source line SB is electrically connected to the third electrode 23. The second electrodes 2s of the plurality of light leakage transistors 12 are all electrically connected to a second source line SW, and the second source line SW is electrically connected to the fourth electrode 24. The second electrodes 3s and the first electrodes 3d of the plurality of dummy transistors 13 are not connected to the second electrodes 1s and the first electrodes 1d of the plurality of light-shielding transistors 11 as well as the second electrodes 2s and the first electrodes 2d of the plurality of light leakage transistors 12, respectively.

For example, referring to FIG. 4A, the second electrodes 3s of the plurality of dummy transistors 13 are electrically connected through a dummy source line XS, and the dummy source line XS is electrically isolated from the first source line SB and the second source line SW. The first electrodes 3d of the plurality of dummy transistors 13 are not connected and are in a floating state.

For example, referring to FIG. 4B, the first electrodes 3d of the plurality of dummy transistors 13 are electrically connected through a dummy drain line XD, and the dummy drain line XD is electrically isolated from the drain signal line DL. The second electrodes 3s of the plurality of dummy transistors 13 are not connected and are in a floating state.

For example, referring to FIG. 3, there is no connection between the first electrodes 3d of the plurality of dummy transistors 13, and the first electrodes 3d of the plurality of dummy transistors 13 are electrically isolated from the first source line SB and the second source line SW. There is no connection between the second electrodes 3s of the plurality of dummy transistors 13, and the second electrodes 3s of the plurality of dummy transistors 13 are electrically isolated from the first source line SB and the second source line SW.

The working process of the above-mentioned light-sensing unit 10 is, for example, as follows. The dimming chip outputs electrical signals to multiple electrodes. The first electrode 21 transmits a gate control signal, and the gate control signal is transmitted to the plurality of light-shielding transistors 11 and the plurality of light leakage transistors 12 through the gate signal line GL, so that the plurality of light-shielding transistors 11 and the plurality of light leakage transistors 12 are turned on. The second electrode 22 transmits a drain signal, and the drain signal is transmitted to the plurality of light-shielding transistors 11 and the plurality of light leakage transistors 12 through the drain signal line DL. The plurality of light leakage transistors 12 generate a large light-sensing current under the influence of light, and the light-sensing current is transmitted to the fourth electrode 24 through the second source line SW. The plurality of light-shielding transistors 11 are not affected by light and generate a dark current, and the dark current is transmitted to the third electrode 23 through the first source line SB. Thus, the light-sensing current and the dark current are transmitted to the dimming chip. The dummy transistors do not work.

In the above layout, the dummy unit 3 is also arranged in the first region B1, so that the transistors in the light-sensing unit 10 may fully occupy the first region along the second direction X, which may ensure that the film layer environments of the transistors in the light-sensing unit 10 are consistent. Thus, the occurrence of moiré fringes generated in the rubbing process in the manufacturing process of the display product may be reduced, thereby ensuring the uniformity of brightness and chromaticity of the display product. For example, in a display panel in a high transmittance display mode (high transmittance advanced super dimension switch, HADS), a direction of the rubbing process is a short side direction of the display panel (i.e., the first direction Y). Since the transistors in the light-sensing unit 10 are arranged uniformly in the second direction X, the risk of rubbing may be reduced. In addition, since there is no electrical connection between the dummy transistor 13 in the dummy unit 3 and the light-shielding transistor 11 as well as the light leakage transistor 12, no signal is input into the dummy transistor 13, which will not affect the normal operations of the light-shielding transistor 11 and the light leakage transistor 12.

In some examples, as shown in FIGS. 3 to 4B, the dummy unit 3 is arranged between the light-shielding unit 1 and the light leakage unit 2; the plurality of light-shielding transistors 11 are arranged along the second direction X, the plurality of light leakage transistors 12 are arranged along the second direction X, and the plurality of dummy transistors 13 are arranged along the second direction X. The light-shielding unit 1, the dummy unit 3 and the light leakage unit 2 are arranged along the second direction X; and correspondingly, the third electrode 23 and the fourth electrode 24 are respectively arranged at two ends of the plurality of bonding electrodes 20 along the second direction X. With such the arrangement, the plurality of light-shielding transistors 11 are arranged close to the third electrode 23, and the plurality of light leakage transistors 12 are arranged close to the fourth electrode 24, which facilitates the arrangement of the first source line SB and the second source line SW. For example, the first source line SB is connected to the second electrodes 1s of the plurality of light-shielding transistors 11, and is connected to the third electrode 23 through the third region B3. The second source line SW is connected to the second electrodes 2s of the plurality of light leakage transistors 12, and is connected to the fourth electrode 24 through the fourth region B4. Thus, it avoids unnecessary winding, and the difficulty of wiring is reduced.

For example, the second electrode 22 is close to the third region B3, and the first electrode 21 is close to the fourth region B4, so that the drain signal line DL and the gate signal line GL are respectively arranged in the third region B3 and the fourth region B4. For example, the drain signal line DL is connected to the first electrodes 1d of the plurality of light-shielding transistors 11 and the first electrodes 2d of the plurality of light leakage transistors 12, and is connected to the second electrode 22 through the third region B3. The gate signal line GL is connected to the control electrodes 1k of the plurality of light-shielding transistors 11 and the control electrodes 2k of the plurality of light leakage transistors 12, and is connected to the first electrode 21 through the fourth region B4. Thus, it avoids unnecessary winding, and the difficulty of wiring is reduced.

In some other embodiments, referring to FIG. 5, the light-sensing unit 10 is located in the second region B2; the plurality of light-shielding transistors 11 are arranged along the second direction X, the plurality of light leakage transistors 12 are arranged along the second direction X, and the plurality of dummy transistors 13 are arranged along the second direction X. The light-sensing unit 10 includes the light-shielding unit 1, the light leakage unit 2 and the dummy unit 3, and the light-shielding unit 1, the dummy unit 3 and the light leakage unit 2 are arranged along the second direction X; and the dummy unit 3 is arranged between the light-shielding unit 1 and the light leakage unit 2. Multiple groups of fan-out wires 40 are provided between the display region AA and the bonding region CC, an interval region Q is provided between any two adjacent groups of fan-out wires 40 in the multiple groups of fan-out wires 40, and interval regions Q include a first interval region Q1, a second interval region Q2 and a third interval region Q3; the light-shielding unit 1 is located in the first interval region Q1, the light leakage unit 2 is located in the second interval region Q2, and the dummy unit 3 is located in the third interval region Q3. The first electrode 21 includes a first sub-electrode 21a and a second sub-electrode 21b, and the second electrode 22 includes a third sub-electrode 22a and a fourth sub-electrode 22b. Gate signal lines GL include a first gate line GL1, a second gate line GL2 and a dummy gate line XG, and drain signal lines DL include a first drain line DL1, a second drain line DL2 and a dummy drain line XD.

The control electrodes 1k of the plurality of light-shielding transistors 11 are electrically connected in sequence through the first gate line GL1, and the first gate line GL1 is electrically connected to the first sub-electrode 21a. The first electrodes 1d of the plurality of light-shielding transistors 11 are electrically connected in sequence through the first drain line DL1, and the first drain line DL1 is electrically connected to the third sub-electrode 22a. The control electrodes 2k of the plurality of light leakage transistors 12 are electrically connected in sequence through the second gate line GL2, and the second gate line GL 2 is electrically connected to the second sub-electrode 21b. The first electrodes 2d of the plurality of light leakage transistors 12 are electrically connected in sequence through the second drain line DL2, and the second drain line DL2 is electrically connected to the fourth sub-electrode 22b. The control electrodes 3k of the plurality of dummy transistors 13 are electrically connected in sequence through the dummy gate line XG, and the dummy gate line XG is electrically connected to a dummy electrode 25; the second electrodes 3s of the plurality of dummy transistors 13 are electrically connected in sequence through a dummy source line XS, and the dummy source line XS is electrically connected to a dummy electrode 25; the first electrodes 3d of the plurality of dummy transistors 13 are electrically connected in sequence through the dummy drain line XD, and the dummy drain line XD is electrically connected to a dummy electrode 25.

As a possible implementation, the first electrodes 3d of the plurality of dummy transistors 13 are not connected to each other and are in a floating state; and/or the second electrodes 3s of the plurality of dummy transistors 13 are not connected to each other and are in a floating state.

The working process of the above-mentioned light-sensing unit 10 is, for example, as follows. The dimming chip outputs electrical signals to multiple electrodes. The first sub-electrode 21a and the second sub-electrode 21b transmit gate control signals, and the gate control signals are transmitted to the plurality of light-shielding transistors 11 and the plurality of light leakage transistors 12 through the first gate line GL1 and the second gate line GL2 respectively, so that the plurality of light-shielding transistors 11 and the plurality of light leakage transistors 12 are turned on. The third sub-electrode 22a and the fourth sub-electrode 22b transmit drain signals, and the drain signals are transmitted to the plurality of light-shielding transistors 11 and the plurality of light leakage transistors 12 through the first drain line DL1 and the second drain line DL2 respectively. The plurality of light leakage transistors 12 generate a large light-sensing current under the influence of light, and the light-sensing current is transmitted to the fourth electrode 24 through the second source line SW. The plurality of light-shielding transistors 11 are not affected by light and generate a dark current, and the dark current is transmitted to the third electrode 23 through the first source line SB. Thus, the light-sensing current and the dark current are transmitted to the dimming chip.

It should be noted that the dummy electrodes 25 do not provide electrical signals during the above-mentioned working process. That is to say, through the dummy gate line XG, the dummy drain line XD and the dummy source line XS, electrical signals are not input into the dummy transistors 13, and thus there are no electrical connections between the dummy electrodes 25 and the dummy transistors 13. Therefore, the dummy transistors do not work.

For example, the display region AA is provided with a plurality of sub-pixels arranged in an array, a plurality of data lines and a plurality of gate lines. The plurality of data lines extend, for example, along the first direction Y. The multiple groups of fan-out wires 40 are used for connecting the plurality of data lines and bonding electrodes, so that a source driver chip provides data signals for the data lines through the bonding electrodes and the fan-out wires. Each group of fan-out wires 40 includes a plurality of fan-out wires, and the plurality of fan-out wires 40 are concentrated inwardly in a direction from the display region AA to the bonding region CC, to show a fan shape.

In the above layout of the light-sensing unit 10, the light-sensing unit 10 is arranged in the interval regions Q in the second region B2, and each unit in the light-sensing unit 10 is arranged in the gap between two adjacent groups of fan-out wires 40, so that the wiring and device arrangement of the second region B2 are more compact, which may avoid the waste of space of the display panel 100 and make the space utilization rate of the display panel 100 higher. Moreover, due to the arrangement of the dummy unit 3, the film layer environments of the transistors in the light-sensing unit 10 may be ensured to be consistent, thereby reducing the occurrence of moiré fringes generated in the rubbing process in the manufacturing process of the display product, and ensuring the uniformity of brightness and chromaticity of the display product. In addition, since there is no electrical connection between the dummy transistor 13 in the dummy unit 3 and the light-shielding transistor 11 as well as the light leakage transistor 12, no signal is input into the dummy transistor 13, which will not affect the normal operations of the light-shielding transistor 11 and the light leakage transistor 12.

In some examples, as shown in FIG. 5, the plurality of light-shielding transistors 11 are arranged along the second direction X, the plurality of light leakage transistors 12 are arranged along the second direction X, and the plurality of dummy transistors 13 are arranged along the second direction X. The light-sensing unit 10 includes the light-shielding unit 1, the light leakage unit 2 and the dummy unit 3, and the light-shielding unit 1, the dummy unit 3 and the light leakage unit 2 are arranged along the second direction X; and the dummy unit 3 is arranged between the light-shielding unit 1 and the light leakage unit 2. The plurality of dummy transistors 13, the plurality of light-shielding transistors 11 and the plurality of light leakage transistors 12 are arranged along the second direction X. Each of the light-shielding unit 1, the light leakage unit 2 and the dummy unit 3 is located in the interval region Q between two adjacent groups of fan-out wires 40; and correspondingly, the bonding electrodes 20 electrically connected to the light-shielding unit 1 are respectively arranged on both sides close to the first interval region Q1 along the second direction X, the bonding electrodes 20 electrically connected to the light leakage unit 2 are respectively arranged on both sides close to the second interval region Q2 along the second direction X, and the bonding electrodes 20 electrically connected to the dummy unit 3 are respectively arranged on both sides close to the third interval region Q3 along the second direction X. With such the arrangement, it facilitates the connections between the light-shielding unit 1, the light leakage unit 2 and the dummy unit 3 in the light-sensing unit 10 and the corresponding bonding electrodes 20, and avoids unnecessary winding, and the difficulty of wiring is reduced.

For example, the third sub-electrode 22a and the third electrode 23 are close to the first interval region Q1, and the fourth sub-electrode 22b and the fourth electrode 24 are close to the second interval region Q2. In this way, the first drain line DL1, the first gate line GL1 and the first source line SB are all arranged in the first interval region Q1, and the second drain line DL2, the second gate line GL2 and the second source line SW are all arranged in the second interval region Q2. For example, the first drain line DL1 is connected to the first electrodes 1d of the plurality of light-shielding transistors 11, and the second drain line DL2 is connected to the first electrodes 2d of the plurality of light leakage transistors 12. The dummy electrodes 25 are close to the third interval region Q3, and the dummy gate line XG, the dummy drain line XD and the dummy source line XS are all arranged in the third interval region Q3. In the process of connecting the above-mentioned signal lines to the corresponding bonding electrodes 20, it is equivalent to shortening the lengths of the signal lines, thereby avoiding unnecessary winding, and reducing the difficulty of wiring.

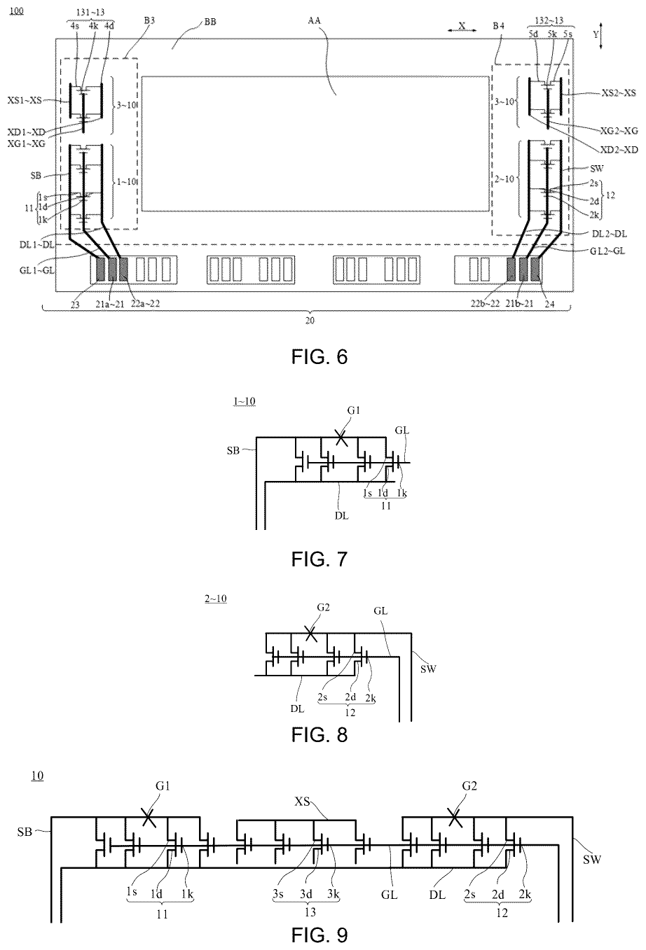

In yet some other embodiments, referring to FIG. 6, the light-shielding unit 1 is located in the third region B3, and the light leakage unit 2 is located in the fourth region B4; the plurality of dummy transistors 13 in the dummy unit 3 include a plurality of first dummy transistors 131 and a plurality of second dummy transistors 132, the plurality of first dummy transistors 131 are located in the third region B3, and the plurality of second dummy transistors 132 are located in the fourth region B4. The plurality of light-shielding transistors 11 are arranged along the first direction Y, the plurality of light leakage transistors 12 are arranged along the first direction Y, the plurality of first dummy transistors 131 are arranged along the first direction Y, and the plurality of second dummy transistors 132 are arranged along the first direction Y. The light-shielding unit 1 and the plurality of first dummy transistors 131 are arranged along the first direction Y, and the light leakage unit 2 and the plurality of second dummy transistors 132 are arranged along the first direction Y; the plurality of first dummy transistors 131 are away from the plurality of bonding electrodes 20 relative to the plurality of light-shielding transistors 11, and the plurality of second dummy transistors 132 are away from the plurality of bonding electrodes 20 relative to the plurality of light leakage transistors 12. The first electrode 21 includes a first sub-electrode 21a and a second sub-electrode 21b, and the second electrode 22 includes a third sub-electrode 22a and a fourth sub-electrode 22b. Gate signal lines GL include a first gate line GL1, a second gate line GL2 and dummy gate lines XG, and drain signal lines DL include a first drain line DL1, a second drain line DL2 and dummy drain lines XD; the dummy gate lines XG include a first dummy gate line XG1 and a second dummy gate line XG2, and the dummy drain lines XD include a first dummy drain line XD1 and a second dummy drain line XD2; and dummy source lines XD includes a first dummy source line XS1 and a second dummy source line XS2.

The control electrodes 1k of the plurality of light-shielding transistors 11 are electrically connected in sequence through the first gate line GL1, and the first gate line GL1 is electrically connected to the first sub-electrode 21a; the first electrodes 1d of the plurality of light-shielding transistors 11 are electrically connected in sequence through the first drain line DL1, and the first drain line DL1 is electrically connected to the third sub-electrode 22a. The control electrodes 2k of the plurality of light leakage transistors 12 are all electrically connected to the second gate line GL2, and the second gate line GL 2 is electrically connected to the second sub-electrode 21b; the first electrodes 2d of the plurality of light leakage transistors 12 are all electrically connected to the second drain line DL2, and the second drain line DL2 is electrically connected to the fourth sub-electrode 22b.

In some examples, the control electrodes 4k of the plurality of first dummy transistors 131 are electrically connected in sequence through the first dummy gate line XG1, the second electrodes 4s of the plurality of first dummy transistors 131 are electrically connected in sequence through the first dummy source line XS1, and the first electrodes 4d of the plurality of first dummy transistors 131 are electrically connected in sequence through the first dummy drain line XD1. The control electrodes 5k of the plurality of second dummy transistors 132 are electrically connected in sequence through the second dummy gate line XG2, the second electrodes 5s of the plurality of second dummy transistors 132 are electrically connected in sequence through the second dummy source line XS2, and the first electrodes 5d of the plurality of second dummy transistors 132 are electrically connected in sequence through the second dummy drain line XD2. For example, the plurality of first dummy transistors 131 have no electrical relationship with the plurality of light-shielding transistors 11, and the plurality of second dummy transistors 132 have no electrical relationship with the plurality of light leakage transistors 12. Alternatively, the first dummy drain line XD1 is electrically connected to the first drain line DL1, and the first dummy gate line XG1 is electrically connected to the first gate line GL1. That is, there is an electrical relationship between the first electrodes 4d/control electrodes 4k of the plurality of first dummy transistors 131 and the first electrodes 1d/control electrodes 1k of the plurality of light-shielding transistors 11. Since the second electrodes of the first dummy transistors 131 are not connected to the electrode, the first dummy transistors 131 do not work. For the second dummy transistors 132, reference is made to the connection manners of the plurality of first dummy transistors 131, which will not be repeated here.

As a possible implementation, the first electrodes 4d of the plurality of first dummy transistors 131 are not connected to each other and are in a floating state, and/or the second electrodes 4s of the plurality of first dummy transistors 13 are not connected to each other and are in a floating state. Alternatively, the first electrodes 5d of the plurality of second dummy transistors 132 are not connected to each other and are in a floating state, and/or the second electrodes 5s of the plurality of second dummy transistors 132 are not connected to each other and are in a floating state.

The working process of the above-mentioned light-sensing unit is, for example, as follows. The dimming chip outputs electrical signals to multiple electrodes. The first sub-electrode 21a and the second sub-electrode 21b transmit gate control signals, and the gate control signals are transmitted to the plurality of light-shielding transistors 11 and the plurality of light leakage transistors 12 through the first gate line GL1 and the second gate line GL2 respectively, so that the plurality of light-shielding transistors 11 and the plurality of light leakage transistors 12 are turned on. The third sub-electrode 22a and the fourth sub-electrode 22b transmit drain signals, and the drain signals are transmitted to the plurality of light-shielding transistors 11 and the plurality of light leakage transistors 12 through the first drain line DL1 and the second drain line DL2 respectively. The plurality of light leakage transistors 12 generate a large light-sensing current under the influence of light, and the light-sensing current is transmitted to the fourth electrode 24 through the second source line SW. The plurality of light-shielding transistors 11 are not affected by light and generate a dark current, and the dark current is transmitted to the third electrode 23 through the first source line SB. Thus, the light-sensing current and the dark current are transmitted to the dimming chip.

It should be noted that, referring to FIG. 6, it can be seen from the figure that the plurality of first dummy transistors 131 have no electrical relationship with the plurality of light-shielding transistors 11, or the two have an electrical relationship but the second electrodes of the first dummy transistors 131 are not connected to the electrode; the plurality of second dummy transistors 132 have no electrical relationship with the plurality of light leakage transistors 12, or the two have an electrical relationship but the second electrodes of the second dummy transistors 132 are not connected to the electrode; and the plurality of first dummy transistors 131 and the plurality of second dummy transistors 132 have no input and output of electrical signals. Therefore, in the above-mentioned working process, the plurality of first dummy transistors 131 and the plurality of second dummy transistors 132 do not work.

In the above layout, the plurality of light-shielding transistors 11 are arranged along the first direction Y, the plurality of light leakage transistors 12 are arranged along the first direction Y, the plurality of first dummy transistors 131 are arranged along the first direction Y, and the plurality of second dummy transistors 132 are arranged along the first direction Y. The plurality of dummy transistors 13 are divided into the plurality of first dummy transistors 131 and the plurality of second dummy transistors 132. In the third region B3, the plurality of first dummy transistors 131 and the light-shielding unit 1 both extend along the first direction Y. In the fourth region B4, the plurality of second dummy transistors 132 and the light leakage unit 2 both extends along the first direction Y. This may ensure that the film layer environments of the transistors in the light-sensing unit 10 are consistent, thereby reducing the occurrence of moiré fringes generated in the rubbing process in the manufacturing process of the display product, and ensuring the uniformity of brightness and chromaticity of the display product. For example, in a case where the display panel adopts an ADS (advanced super dimension switch) display mode, a rubbing direction of the rubbing process is a long side direction of the display panel 100 (i.e., the second direction X). Since the transistors in the light-sensing unit 10 are arranged uniformly in the first direction Y, the risk of rubbing may be reduced.

In some examples, as shown in FIG. 6, the plurality of first dummy transistors 131 are away from the plurality of bonding electrodes 20 relative to the plurality of light-shielding transistors 11, and the plurality of second dummy transistors 132 are away from the plurality of bonding electrodes 20 relative to the plurality of light leakage transistors 12; and correspondingly, the bonding electrodes 20 connected to the plurality of light-shielding transistors 11 and the bonding electrodes connected to the plurality of light leakage transistors 12 are respectively arranged at two ends of the plurality of bonding electrodes 20 along the second direction X. With such the arrangement, it facilitates the wiring of the signal lines for connecting the transistors and the corresponding bonding electrodes 20, which may shorten the lengths of the signal lines, avoid unnecessary winding or crossing, and reduce the wiring difficulty.

For example, the third sub-electrode 22a and the third electrode 23 are arranged close to the third region B3, and the fourth sub-electrode 22b and the fourth electrode 24 are arranged close to the fourth region B4. In this way, the first drain line DL1, the first gate line GL1 and the first source line SB that are connected to the plurality of light-shielding transistors 11 are close to the corresponding bonding electrodes, and the second drain line DL2, the second gate line GL2 and the second source line SW that are connected to the plurality of light leakage transistors 12 are close to the corresponding bonding electrodes. In the process of connecting the above-mentioned signal lines to the corresponding bonding electrodes 20, it is equivalent to shortening the lengths of the signal lines, thereby avoiding unnecessary winding or crossing, and reducing the difficulty of wiring.

Usually, when ambient light is detected, light-sensing transistors are used as light-sensing elements. The number of light-sensing transistors in the display panel needs to be determined by simulating the current size and combining the actual measurement of the characteristics of the light-sensing transistors. At the same time, the current monitoring situation of the circuit needs to be matched. Therefore, after the number of light-sensing transistors in the display panel is determined, there may be improper matching during the subsequent debugging process of the circuit. Based on this, the following embodiments of the present disclosure provide specific solutions for reasonably selecting the number of light-sensing transistors by laser cutting/welding during the debugging stage of the light-sensing circuit.

The following describes solutions for changing the number of light-shielding transistors/light leakage transistors by laser cutting.

In some embodiments, referring to FIG. 7, the control electrodes 1k of the plurality of light-shielding transistors 11 are all electrically connected to the gate signal line GL, and the first electrodes 1d of the plurality of light-shielding transistors 11 are all electrically connected to the drain signal line DL. On this basis, the second electrodes 1s of the plurality of light-shielding transistors 11 are all electrically connected to the first source line SB; and there is at least one first cutting position G1 on the first source line SB, and a first cutting position G1 is located between the second electrodes of any two adjacent light-shielding transistors 11.

In some other embodiments, referring to FIG. 8, the control electrodes 2k of the plurality of light leakage transistors 12 are all electrically connected to the gate signal line GL, and the first electrodes 2d of the plurality of light leakage transistors 12 are all electrically connected to the drain signal line DL. On this basis, the second electrodes 2s of the plurality of light leakage transistors 12 are all electrically connected to the second source line SW; and there is at least one second cutting position G2 on the second source line SW, and a second cutting position G2 is located between the second electrodes of any two adjacent light leakage transistors 12.

In yet some other embodiments, referring to FIG. 9, the control electrodes 1k of the plurality of light-shielding transistors 11 are all electrically connected to the gate signal line GL, and the first electrodes 1d of the plurality of light-shielding transistors 11 are all electrically connected to the drain signal line DL; the control electrodes 2k of the plurality of light leakage transistors 12 are all electrically connected to the gate signal line GL, and the first electrodes 2d of the plurality of light leakage transistors 12 are all electrically connected to the drain signal line DL. On this basis, the second electrodes 1s of the plurality of light-shielding transistors 11 are all electrically connected to the first source line SB; and there is at least one first cutting position G1 on the first source line SB, and a first cutting position G1 is located between the second electrodes of any two light-shielding transistors 11; and the second electrodes 2s of the plurality of light leakage transistors 12 are all electrically connected to the second source line SW; and there is at least one second cutting position G2 on the second source line SW, and a second cutting position G2 is located between the second electrodes of any two adjacent light leakage transistors 12.

The above-mentioned first cutting position G1 and the second cutting position G2 are mainly used for selecting the numbers of light-shielding transistors 11 and light leakage transistors 12 that are in a working state in the light-sensing unit 10. During the circuit debugging process, if it is found that the number of designed light-shielding transistors 11 is too large, or the number of designed light leakage transistors 12 is too large, the first cutting position G1 on the first source line SB for connecting the plurality of light-shielding transistors 11 can be cut by the laser, or the second cutting position G2 on the second source line SW for connecting the plurality of light leakage transistors 12 can be cut by the laser. Thus, the number of actually working light-shielding transistors 11 and the number of actually working light leakage transistors 12 may be changed. For example, referring to FIG. 9, if the first cutting position G1 is cut by the laser (that is, the first cutting position G1 is taken as a critical position), among the plurality of light-shielding transistors 11, light-shielding transistor(s) 11 close to the dummy transistors 13 will not work, and light-shielding transistor(s) 11 far away from the dummy transistors 13 are retained and continue to work, which is equivalent to reducing the number of light-shielding transistors 11. If the second cutting position G2 is cut by the laser (that is, the second cutting position G2 is taken as a critical position), among the plurality of light leakage transistors 12, light leakage transistor(s) 12 close to the dummy transistors 13 will not work, and light leakage transistor(s) 12 far away from the dummy transistors 13 are retained and continue to work, which is equivalent to reducing the number of light leakage transistors 12. By performing the laser cutting at an appropriate position, it is ensured that the numbers of light-shielding transistors 11 and light leakage transistors 12 in the light-sensing unit 10 are set within a reasonable range in a process of the dimming chip adjusting the light brightness.

It should be noted that the arrangement of the first cutting position(s) G1 on the first source line SB and the arrangement of the at least one second cutting position G2 on the second source line SW are applicable to the solution corresponding to any one of FIGS. 3 to 6.

The following describes solutions for changing the number of light-shielding transistors/light leakage transistors by laser welding.

In some embodiments, as shown in FIGS. 10A to 10C, the light-sensing unit 10 is located in the first region B1. The control electrodes 3k of the plurality of dummy transistors 13 are electrically connected to the control electrodes 1k of the plurality of light-shielding transistors 11 and the control electrodes 2k of the plurality of light leakage transistors 12 (for example, they are all electrically connected to the gate signal line GL). The first electrodes 3d of the plurality of dummy transistors 13 are electrically connected in sequence, and are electrically connected to the first electrodes 1d of the plurality of light-shielding transistors 11 and the first electrodes 2d of the plurality of light leakage transistors 12 (for example, they are all electrically connected to the drain signal line DL). The second electrodes 3s of the plurality of dummy transistors 13 are all electrically connected to the dummy source line XS.

In some examples, referring to FIG. 10A, there is a first welding position R1 between the first source line SB and the dummy source line XS, and the first source line SB and the dummy source line XS can be electrically connected at the first welding position R1 under the action of external force.

In some other examples, referring to FIG. 10B, there is a second welding position R2 between the second source line SW and the dummy source line XS, and the second source line SW and the dummy source line XS can be electrically connected at the second welding position R2 under the action of external force.

In yet some other examples, as shown in FIG. 10C, there is a first welding position R1 between the first source line SB and the dummy source line XS, and there is a second welding position R2 between the second source line SW and the dummy source line XS. During the actual debugging process, one of the first welding position R1 and the second welding position R2 is selected for welding as needed.

It should be noted that, in the above-mentioned light-sensing unit 10, there is no electrical connection between the first source line SB and the dummy source line XS, there is no electrical connection between the second source line SW and the dummy source line XS, and the dummy transistors do not work. During the circuit debugging process, it is necessary to use an external force (e.g., laser) to enable the first source line SB and the dummy source line XS to be welded, or to enable the second source line SW and the dummy source line XS to be welded, so that the dummy transistors 13 in the dummy unit 3 can receive the electrical signal.

The arrangement of the first welding position R1 and the second welding position R2 may adjust the number of actually working light-shielding transistors and/or the number of actually working light leakage transistors. During the circuit debugging process, if it is found that the number of designed light-shielding transistors 11 is too small, or the number of designed light leakage transistors 12 is too small, the first welding position R1 between the first source line SB and the dummy source line XS is acted by the laser, so that the first source line SB and the dummy source line XS are welded at the first welding position R1 to achieve electrical connection. In this case, the plurality of dummy transistors 13 in the dummy unit 3 and the plurality of light-shielding transistors 11 can receive the same signal, and the dummy transistors 13 can play the role of the light-shielding transistors 11, which is equivalent to converting all the dummy transistors 13 into light-shielding transistors 11, thereby increasing the number of light-shielding transistors 11. Similarly, the second welding position R2 between the second source line SW and the dummy source line XS is acted by the laser, so that the second source line SW and the dummy source line XS are welded at the second welding position R2 to achieve electrical connection. In this case, the plurality of dummy transistors 13 in the dummy unit 3 and the plurality of light leakage transistors 12 can receive the same signal, and the dummy transistors 13 can play the role of the light leakage transistors 12, which is equivalent to converting all the dummy transistors 13 into light leakage transistors 12, thereby increasing the number of light leakage transistors 12. Therefore, the arrangement of the first welding position R1 and the second welding position R2 can ensure that the numbers of light-shielding transistors 11 and light leakage transistors 12 in the light-sensing unit 10 are controlled to be within a reasonable range in a process of the dimming chip adjusting the light brightness.

In some embodiments, referring to FIG. 10D, the dummy source line XS includes at least two dummy source sub-lines XSa that are disconnected, and there is a third welding position R3 between two adjacent dummy source sub-lines XSa. The two adjacent dummy source sub-lines XSa can be electrically connected at the third welding position R3 under the action of external force.

For example, referring to FIG. 10D, the dummy source line XS includes three dummy source sub-lines XSa that are disconnected, and there is a third welding position R3 between two adjacent dummy source sub-lines XSa. In FIG. 10C, the first welding position R1 and the second welding position R2 are also included. The plurality of dummy transistors 13 are divided into three groups according to multiple welding positions, and each group includes two dummy transistors. Hereinafter, two dummy transistors between the first welding position R1 and a third welding position R3 close to the light-shielding unit 1 are referred to as a first group of dummy transistors, two dummy transistors between two adjacent third welding positions R3 are referred to as a second group of dummy transistors, and two dummy transistors between a third welding position R3 close to the light leakage unit 2 and the second welding position R2 are referred to as a third group of dummy transistors. The first welding position R1 is position a, the third welding position R3 close to the light-shielding unit 1 is position b, the third welding position R3 close to the light leakage unit 2 is position c, and the second welding position R2 is position d.

As shown in FIG. 10D, in a case where the first welding position R1 (position a) between the first source line SB and the dummy source line XS is welded by using the laser welding process, the first group of dummy transistors and the plurality of light-shielding transistors 11 can receive the same signal, and the first group of dummy transistors can play the role of the light-shielding transistors 11 (that is, the number of light-shielding transistors 11 is increased). On this basis, if the number of light-shielding transistors 11 is still insufficient in a process of the dimming chip adjusting the light brightness, the dummy source sub-lines XSa at both ends of the third welding position R3 (position b) close to the light-shielding unit 1 can also be electrically connected by the laser welding process. In this case, the second group of dummy transistors also receives the source signal of the first source line SB, thereby increasing the number of light-shielding transistors 11. Similarly, the third welding position R3 (position c) close to the light leakage unit 2 is electrically connected, and the third group of dummy transistors can also receive the source signal of the first source line SB, which further increases the number of light-shielding transistors, thereby achieving a reasonable adjustment of the number of light-shielding transistors.

With continued reference to FIG. 10D, in a case where the second welding position R2 (position d) between the second source line SW and the dummy source line XS is welded by using the laser welding process, the third group of dummy transistors and the plurality of light leakage transistors 12 can receive the same signal, and the third group of dummy transistors can play the role of the light leakage transistors 12 (that is, the number of light leakage transistors 12 is increased). On this basis, if the number of light leakage transistors 12 is still insufficient in a process of the dimming chip adjusting the light brightness, the dummy source sub-lines XSa at both ends of the third welding position R3 (position c) close to the light leakage unit 2 can also be electrically connected by the laser welding process. In this case, the second group of dummy transistors also receives the source signal of the second source line SW, thereby increasing the number of light leakage transistors 12. Similarly, the third welding position R3 (position b) close to the light-shielding unit 1 is electrically connected, and the first group of dummy transistors can also receive the source signal of the second source line SW, which further increases the number of light leakage transistors 12, thereby achieving a reasonable adjustment of the number of light leakage transistors 12.

In yet some other examples, the first welding position R1 (position a) between the first source line SB and the dummy source line XS is welded by using the laser welding process, so that the first group of dummy transistors and the plurality of light-shielding transistors 11 can receive the same signal, and the first group of dummy transistors is converted into light-shielding transistors 11. At the same time, the second welding position R2 (position d) between the second source line SW and the dummy source line XS is welded by using the laser welding process, so that the third group of dummy transistors and the plurality of light leakage transistors 12 can receive the same signal, and the third group of dummy transistors is converted into light leakage transistors 12. There is no welding at the two third welding positions R3. That is, there is no electrical connection between the dummy source sub-line XSa electrically connected to the second group of dummy transistors and other signal lines, and the second group of dummy transistors does not receive electrical signals and still do not work.

The above only provides several examples of the first welding position R1, the second welding position R2 and the third welding position R3 during use. The number of third welding positions R3 can be more, and multiple choices can be made as needed during the actual debugging process. The arrangement of the third welding position R3 may adjust the numbers of light-shielding transistors 11 and light leakage transistors 12 more reasonably and accurately according to the need to adjust the light brightness.

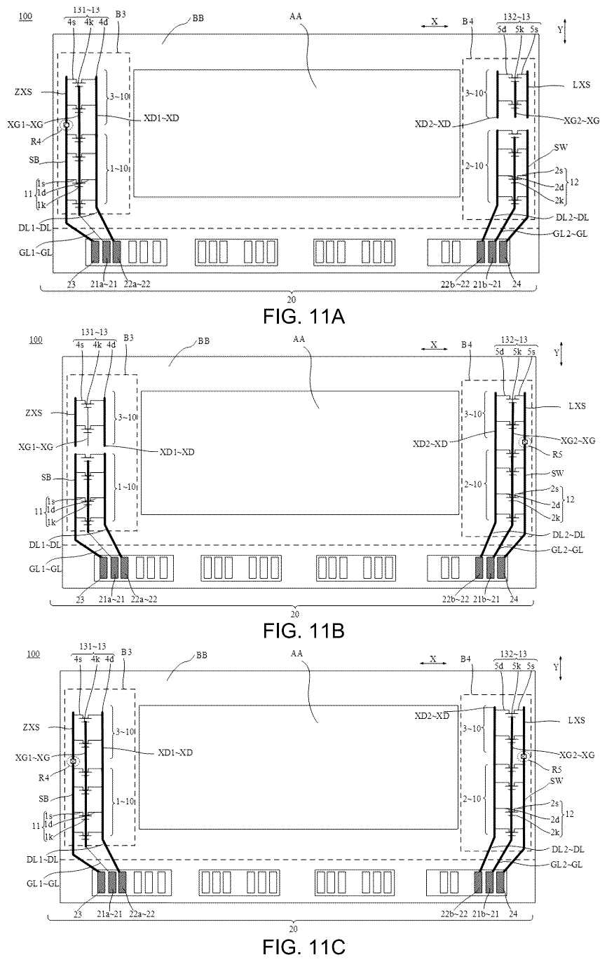

In some embodiments, referring to FIG. 11A, the light-shielding unit 1 is located in the third region B3, and the light leakage unit 2 is located in the fourth region B4. The control electrodes 4k of the plurality of first dummy transistors 131 and the control electrodes 1k of the plurality of light-shielding transistors 11 are electrically connected (for example, they are all electrically connected to the first gate line GL1). The first electrodes 4d of the plurality of first dummy transistors 131 and the first electrodes 1d of the plurality of light-shielding transistors 11 are electrically connected (for example, they are all electrically connected to the first drain line DL1). The second electrodes 4s of the plurality of first dummy transistors 131 are all electrically connected to a light-shielding dummy source line ZXS. There is a fourth welding position R4 between the first source line SB and the light-shielding dummy source line ZXS, and the first source line SB and the light-shielding dummy source line ZXS can be electrically connected at the fourth welding position R4 under the action of external force.

In some other embodiments, referring to FIG. 11B, the light-shielding unit 1 is located in the third region B3, and the light leakage unit 2 is located in the fourth region B4. The control electrodes 5k of the plurality of second dummy transistors 132 and the control electrodes 2k of the plurality of light leakage transistors 12 are electrically connected (for example, they are all electrically connected to the second gate line GL2). The first electrodes 5d of the plurality of second dummy transistors 132 and the first electrodes 2d of the plurality of light leakage transistors 12 are electrically connected (for example, they are all electrically connected to the second drain line DL2). The second electrodes 5s of the plurality of second dummy transistors 132 are all electrically connected to a light leakage dummy source line LXS. There is a fifth welding position R5 between the second source line SW and the light leakage dummy source line LXS, and the second source line SW and the light leakage dummy source line LXS can be electrically connected at the fifth welding position R5 under the action of external force.

In yet some other embodiments, referring to FIG. 11C, the light-shielding unit 1 is located in the third region B3, and the light leakage unit 2 is located in the fourth region B4. The control electrodes 4k of the plurality of first dummy transistors 131 and the control electrodes 1k of the plurality of light-shielding transistors 11 are electrically connected, the first electrodes 4d of the plurality of first dummy transistors 131 and the first electrodes 1d of the plurality of light-shielding transistors 11 are electrically connected, and the second electrodes 4s of the plurality of first dummy transistors 131 are all electrically connected to a light-shielding dummy source line ZXS. There is a fourth welding position R4 between the first source line SB and the light-shielding dummy source line ZXS, and the first source line SB and the light-shielding dummy source line ZXS can be electrically connected at the fourth welding position R4 under the action of external force. The control electrodes 5k of the plurality of second dummy transistors 132 and the control electrodes 2k of the plurality of light leakage transistors 12 are electrically connected, the first electrodes 5d of the plurality of second dummy transistors 132 and the first electrodes 2d of the plurality of light leakage transistors 12 are electrically connected, and the second electrodes 5s of the plurality of second dummy transistors 132 are all electrically connected to a light leakage dummy source line LXS. There is a fifth welding position R5 between the second source line SW and the light leakage dummy source line LXS, and the second source line SW and the light leakage dummy source line LXS can be electrically connected at the fifth welding position R5 under the action of external force.

It should be noted that the arrangement of the fourth welding position R4 and the fifth welding position R5 may adjust the number of actually working light-shielding transistors and/or the number of actually working light leakage transistors. During the circuit debugging process, if it is found that the number of designed light-shielding transistors is too small, or the number of designed light leakage transistors is too small, the fourth welding position R4 between the first source line SB and the light-shielding dummy source line ZXS is acted by the laser, so that the first source line SB and the light-shielding dummy source line ZXS are welded at the fourth welding position R4 to achieve electrical connection. In this case, the plurality of first dummy transistors 131 in the dummy unit 3 and the plurality of light-shielding transistors 11 can receive the same signal, and the first dummy transistors 131 can play the role of the light-shielding transistors 11, which is equivalent to converting all the first dummy transistors 131 into light-shielding transistors 11, thereby increasing the number of light-shielding transistors 11. Similarly, the fifth welding position R5 between the second source line SW and the light leakage dummy source line LXS is acted by the laser, so that the second source line SW and the light leakage dummy source line LXS are welded at the fifth welding position R5 to achieve electrical connection. In this case, the plurality of second dummy transistors 132 in the dummy unit 3 and the plurality of light leakage transistors 12 can receive the same signal, and the second dummy transistors 132 can play the role of the light leakage transistors 12, which is equivalent to converting all the second dummy transistors 132 into light leakage transistors 12, thereby increasing the number of light leakage transistors 12. Therefore, the arrangement of the fourth welding position R4 and the fifth welding position R5 can ensure that the numbers of light-shielding transistors 11 and light leakage transistors 12 in the light-sensing unit 10 are controlled to be within a reasonable range in a process of the dimming chip adjusting the light brightness.

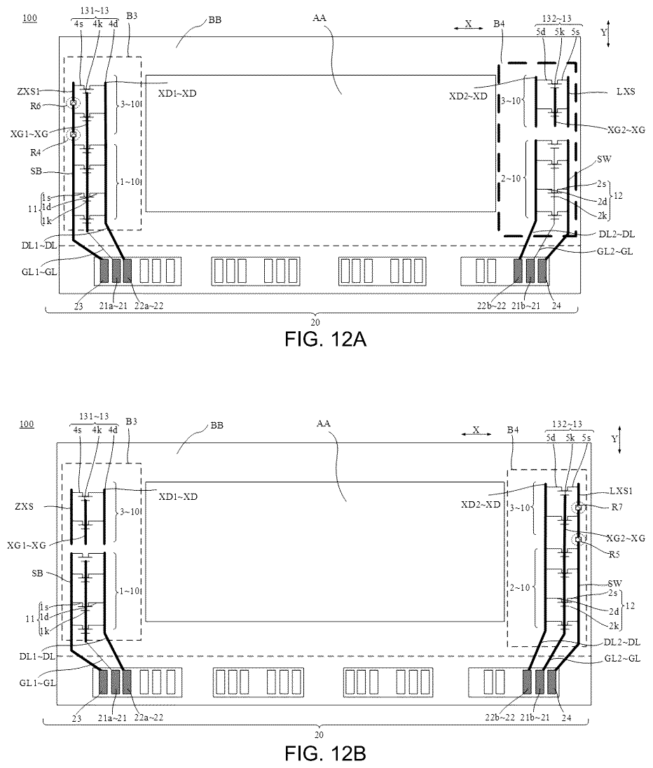

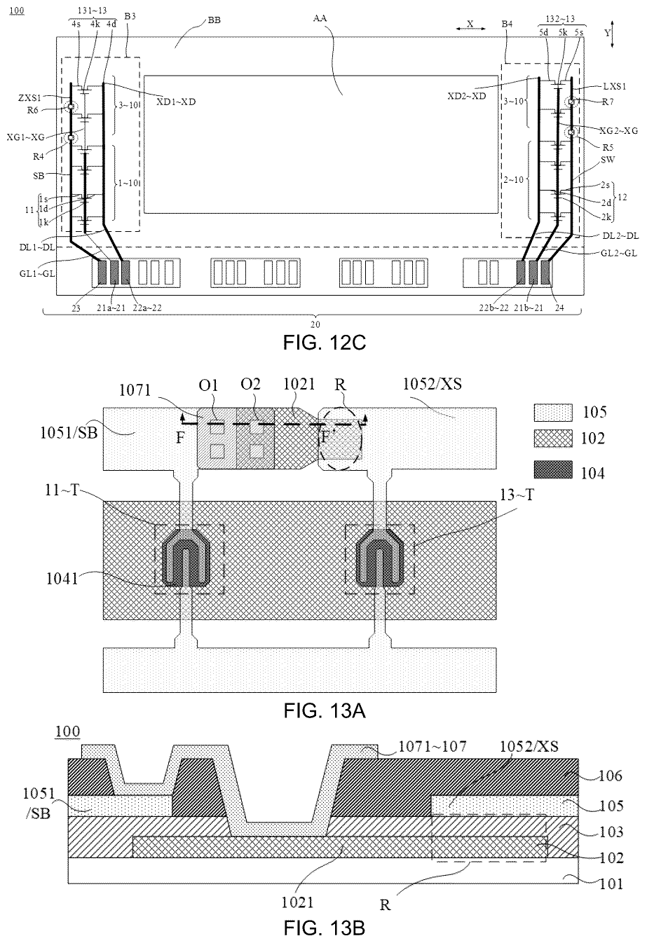

In some embodiments, referring to FIG. 12A, the light-shielding dummy source line ZXS includes at least two light-shielding dummy source sub-lines ZXS1 that are disconnected, and each light-shielding dummy source sub-line ZXS1 is electrically connected to at least one first dummy transistor 131. There is a sixth welding position R6 between two adjacent light-shielding dummy source sub-lines ZXS1, and the two adjacent light-shielding dummy source sub-lines ZXS1 can be electrically connected at the sixth welding position R6 under the action of external force.

For example, referring to FIG. 12A, the light-shielding dummy source line ZXS includes two light-shielding dummy source sub-lines ZXS1 that are disconnected, and there is a sixth welding position R6 between the two adjacent light-shielding dummy source sub-lines ZXS1. In an example where the dummy unit 3 includes two first dummy transistors 131, each first dummy transistor 131 is electrically connected to one light-shielding dummy source sub-line ZXS1. With reference to the above description, in a case where the fourth welding position R4 between the first source line SB and a light-shielding dummy source sub-line ZXS1 close to the light-shielding unit 1 is welded by using the laser welding process, in the two first dummy transistors 131, a first dummy transistor 131 close to the light-shielding unit 1 receives the signal transmitted by the first source line SB, which is equivalent to converting the first dummy transistor 131 into a light-shielding transistor, and the other first dummy transistor 131 does not receive the signal. On this basis, if the number of light-shielding transistors is still insufficient, the sixth welding position R6 between the two light-shielding dummy source sub-lines ZXS1 is welded by the laser, and then the two first dummy transistors 131 can both receive the signal transmitted by the first source line SB. Through the above-mentioned laser welding process and the arrangement of corresponding welding positions, the number of light-shielding transistors 11 is more finely controlled to keep it within a reasonable range.

In some embodiments, referring to FIG. 12B, the light leakage dummy source line LXS includes at least two light leakage dummy source sub-lines LXS1 that are disconnected, and each light leakage dummy source sub-line LXS1 is electrically connected to at least one second dummy transistor 132. There is a seventh welding position R7 between two adjacent light leakage dummy source sub-lines LXS1, and the two adjacent light leakage dummy source sub-lines LXS1 can be electrically connected at the seventh welding position R7 under the action of external force.

For example, referring to FIG. 12B, the light leakage dummy source line LXS includes two light leakage dummy source sub-lines LXS1 that are disconnected, and there is a seventh welding position R7 between the two adjacent light leakage dummy source sub-lines LXS1. In an example where the dummy unit 3 includes two second dummy transistors 132, each second dummy transistor 132 is electrically connected to one light leakage dummy source sub-line LXS1. With reference to the above description, in a case where the fifth welding position R5 between the second source line SW and a light leakage dummy source sub-line LXS1 close to the light leakage unit 2 is welded by using the laser welding process, in the two second dummy transistors 132, a second dummy transistor 132 close to the light leakage unit 2 receives the signal transmitted by the second source line SW, which is equivalent to converting the second dummy transistor 132 into a light leakage transistor 12, and the other second dummy transistor 132 does not receive the signal. On this basis, if the number of light leakage transistors 12 is still insufficient, the seventh welding position R7 between the two light leakage dummy source sub-lines LXS1 is welded by the laser, and then the two second dummy transistors 132 can both receive the signal transmitted by the second source line SW. Through the above-mentioned laser welding process and the arrangement of corresponding welding positions, the number of light leakage transistors 12 is more finely controlled to keep it within a reasonable range.

In some embodiments, referring to FIG. 12C, the light-shielding dummy source line ZXS includes at least two light-shielding dummy source sub-lines ZXS1 that are disconnected, and each light-shielding dummy source sub-line ZXS1 is electrically connected to at least one first dummy transistor 131; there is a sixth welding position R6 between two adjacent light-shielding dummy source sub-lines ZXS1, and the two adjacent light-shielding dummy source sub-lines ZXS1 can be electrically connected at the sixth welding position R6 under the action of external force. The light leakage dummy source line LXS includes at least two light leakage dummy source sub-lines LXS1 that are disconnected, and each light leakage dummy source sub-line LXS1 is electrically connected to at least one second dummy transistor 132; there is a seventh welding position R7 between two adjacent light leakage dummy source sub-lines LXS1, and the two adjacent light leakage dummy source sub-lines LXS1 can be electrically connected at the seventh welding position R7 under the action of external force.

For example, referring to FIG. 12C, the light-shielding dummy source line ZXS includes two light-shielding dummy source sub-lines ZXS1 that are disconnected, and there is a sixth welding position R6 between the two adjacent light-shielding dummy source sub-lines ZXS1. In an example where the dummy unit 3 includes two first dummy transistors 131, each first dummy transistor 131 is electrically connected to one light-shielding dummy source sub-line ZXS1. The light leakage dummy source line LXS includes two light leakage dummy source sub-lines LXS1 that are disconnected, and there is a seventh welding position R7 between the two adjacent light leakage dummy source sub-lines LXS1. In an example where the dummy unit 3 includes two second dummy transistors 132, each second dummy transistor 132 is electrically connected to one light leakage dummy source sub-line LXS1. This arrangement has the same beneficial effects as the aforementioned part, and may more finely control the numbers of light-shielding transistors 11 and light leakage transistors 12 to be within a reasonable range, which will not be repeated here.

The following introduces the structure of film layers included in the display panel, and describes the structure of the welding position and the method for achieving welding.

In some embodiments, referring to FIGS. 13A, 13B and 13C, the display panel 100 further includes a base substrate 101, a gate layer 102, an insulating layer 103, an active layer 104, a metal layer 105, a passivation layer 106 and a connection layer 107. The gate layer 102 is disposed on a side of the base substrate 101, and the gate layer 102 includes a first connection line 1021. The insulating layer 103 is disposed on a side of the gate layer 102 away from the base substrate 101. The active layer 104 is disposed on a side of the insulating layer 103 away from the base substrate 101, and includes a plurality of active patterns 1041. The metal layer 105 is disposed on a side of the active layer 104 away from the base substrate 101; the metal layer 105 includes first electrodes and second electrodes of a plurality of transistors T, and a plurality of signal lines, and the plurality of signal lines include: the first source line SB, the second source line SW, the dummy source line XS, the light-shielding dummy source line ZXS, and the light leakage dummy source line LXS. The passivation layer 106 is disposed on a side of the metal layer 105 away from the base substrate 101. The connection layer 107 is disposed on a side of the passivation layer 106 away from the base substrate 101, and the connection layer 107 includes a second connection line 1071.

Two signal lines that need to be electrically connected under the action of external force are a first signal line 1051 and a second signal line 1052. The second connection line 1071 is electrically connected to the first signal line 1051 through first via hole(s) O1 penetrating through the passivation layer 106, and the second connection line 1071 is electrically connected to the first connection line 1021 through second via hole(s) O2 penetrating through the passivation layer 106 and the insulating layer 103. The first connection line 1021 at least partially overlaps with the second signal line 1052, and an overlapping position of the two is a welding position R. The welding position R includes the first welding position R1, the second welding position R2, the third welding position R3, the fourth welding position R4, the fifth welding position R5, the sixth welding position R6, or the seventh welding position R7.

It should be noted that the first signal line 1051 and the second signal line 1052 are both disposed in the metal layer 105. The first signal line 1051 can be the first source line SB, the second source line SW or the dummy source line XS, and the second signal line 1052 can be the light-shielding dummy source line ZXS or the light leakage dummy source line LXS. The first connection line 1021 at least partially overlaps with the second signal line 1052, which means that orthographic projections of the first connection line 1021 and the second signal line 1052 on the base substrate 101 at least partially overlap, and the position where the orthographic projections of the two overlap is the welding position R. That is to say, the second signal line 1052 located in the metal layer 105 and the first connection line 1021 located in the gate layer 102 are electrically connected by using the laser welding process. FIGS. 13A and 13B show a structural diagram of welding between the light-shielding transistor 11 and the dummy transistor 13, and for the welding structure between other transistors, reference is made to FIGS. 13A, 13B and 13C.

For example, referring to FIGS. 13A, 13B and 13C, FIG. 13A is a structural diagram showing the electrical connection between the first signal line 1051 and the second signal line 1052 at the welding position R (e.g., the first welding position R1), and FIGS. 13B and 13C are sectional views at the section line FF′ in FIG. 13A; FIG. 13B is a structural diagram before the first signal line 1051 and the second signal line 1052 are electrically connected, and FIG. 13C is a structural diagram after the first signal line 1051 and the second signal line 1052 are electrically connected. The first signal line 1051 is the first source line SB, the second signal line 1052 is the dummy source line XS, and the first source line SB and the dummy source line XS are located in the same layer and extend in the same direction. The first connection line 1021 and the second connection line 1071 are arranged between the first source line SB and the dummy source line XS, orthographic projections of the first connection line 1021 and the dummy source line XS on the base substrate 101 partially overlap, and orthographic projections of the second connection line 1071 and the first source line SB on the base substrate 101 partially overlap. The second connection line 1071 located in the connection layer 107 is electrically connected to the first signal line 1051 through the first via hole O1 penetrating through the passivation layer 106, and the second connection line 1071 is electrically connected to the first connection line 1021 located in the gate layer 102 through the second via hole O2 penetrating through the passivation layer 106 and the insulating layer 103. That is to say, the second connection line 1071 can transmit the signal transmitted by the first source line SB to the first connection line 1021. Furthermore, the overlapping portion (welding position R) of the orthographic projections of the first connection line 1021 and the dummy source line XS on the base substrate 101, for example, in the region G, are welded through the action of external force, so as to achieve the electrical connection between the first connection line 1021 and the dummy source line XS, and then achieve the electrical connection between the first source line SB and the dummy source line XS. Thus, it ensures that the first source line SB and the dummy source line XS transmit the same electrical signal.

It should be noted that the region G is only a partial region in the welding position R. Within the welding position R, the position where the first signal line 1051 and the second signal line 1052 can be electrically connected can be referred to as the region G, i.e., the specific action position under the action of external force.

In some embodiments, as shown in FIG. 14, the display panel 100 includes a base substrate, and further includes a light-shielding layer 108 disposed on a side of the light-sensing unit 10 away from the base substrate 101. The light-shielding layer 108 is provided therein with a plurality of openings K that are arranged at intervals, and each of the plurality of openings K exposes one light leakage transistor 12.

It should be noted that, in the light-shielding layer 108 above the corresponding light leakage transistors 12, an opening K is arranged at a corresponding position of each light leakage transistor 12, which may avoid metal reflection of other regions around the light leakage transistor 12 under the irradiation of ambient light, avoid a bright edge phenomenon, and avoid affecting the visual effect of the display panel 100. This arrangement is suitable for small-sized display panels, which ensures that each light leakage transistor 12 can receive sufficient ambient light, thereby making the current generated by the light leakage unit 2 more precise, and making the signal transmitted by the dimming chip more accurate and effective.

In some embodiments, with continued reference to FIG. 14, the light leakage transistor 12 includes an active layer pattern 121, the active layer pattern 121 includes a channel portion 121a, and an orthographic projection of the channel portion 121a on the base substrate 101 is located in a middle position of an orthographic projection of the opening K on the base substrate 101.

In some embodiments, referring to FIG. 15, in a third direction Z1, a distance between a border of the orthographic projection of the channel portion 121a and a border, on the same side as the border of the orthographic projection of the channel portion 121a, of the orthographic projection of the opening K is a first distance H1, and the first distance H1 is in a range of 5 to 6 μm. In a fourth direction Z2, a distance between a border of the orthographic projection of the channel portion 121a and a border, on the same side as the border of the orthographic projection of the channel portion 121a, of the orthographic projection of the opening K is a second distance H2, and the second distance H2 is in a range of 5 to 6 μm. The fourth direction Z2 is a direction pointing from the second electrode 12a to the first electrode 12b of the light leakage transistor 12, and the third direction Z1 is perpendicular to the fourth direction Z2.

For example, referring to FIGS. 14 and 15, the orthographic projection of the channel portion 121a on the base substrate 101 is located in the middle position of the orthographic projection of the opening K on the base substrate 101. That is, the center of the orthographic projection of the channel portion 121a on the base substrate 101 coincides with the center of the orthographic projection of the opening K on the base substrate 101. Referring to FIG. 15, borders of the orthographic projection of the channel portion 121a in the third direction Z1 are a first channel border a1 and a second channel border a2, and borders of the orthographic projection of the channel portion 121a in the fourth direction Z2 are a third channel border a3 and a fourth channel border a4; borders of the orthographic projection of the opening K in the third direction Z1 are a first opening border b1 and a second opening border b2, and borders of the orthographic projection of the opening K in the fourth direction Z2 are a third opening border b3 and a fourth opening border b4. The first distance H1 is a distance between the first channel border a1 and the first opening border b1, or a distance between the second channel border a2 and the second opening border b2. The second distance H2 is a distance between the third channel border a3 and the third opening border b3, or a distance between the fourth channel border a4 and the fourth opening border b4.

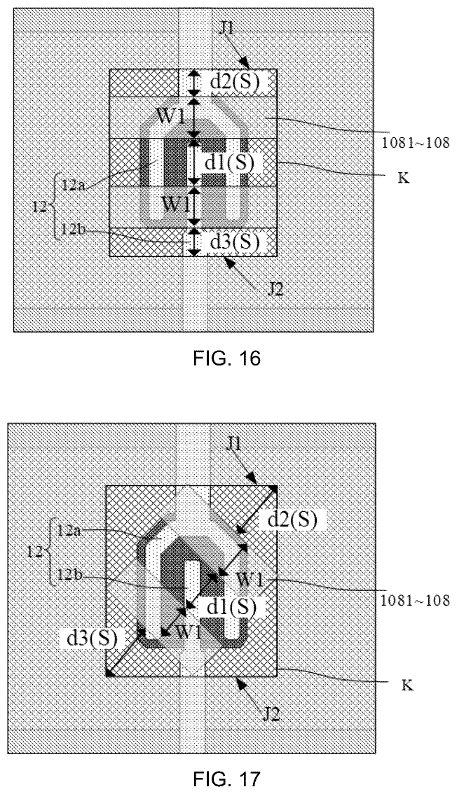

In some embodiments, referring to FIGS. 16 and 17, the light-shielding layer 108 further includes at least one light-shielding strip 1081 disposed in the opening K, and the light-shielding strip(s) 1081 at least partially overlap with the second electrode 12a and the first electrode 12b of the light leakage transistor 12.

For example, referring to FIGS. 16 and 17, the light-shielding layer 108 shown in FIGS. 16 and 17 includes two light-shielding strips 1081 arranged in the opening K; one of the two light-shielding strips 1081 overlaps with the second electrode 12a of the light leakage transistor 12, and the other one of the two light-shielding strips 1081 overlaps with both the second electrode 12a and the first electrode 12b of the light leakage transistor 12. By arranging the light-shielding strips 1081, the second electrode 12a and the first electrode 12b of the light leakage transistor 12 can be at least partially covered to reduce the degree of exposure, thereby reducing the risk of reflection on the surfaces of the second electrode 12a and the first electrode 12b of the light leakage transistor 12 in the lighting environment, and avoiding affecting the appearance of the display product.

In some embodiments, referring to FIGS. 16 and 17, the light-shielding layer 108 includes at least two light-shielding strips 1081, and the at least two light-shielding strips 1081 are arranged in parallel.

For example, with continued reference to FIGS. 16 and 17, two light-shielding strips 1081 are arranged in an opening K in the figure, and the two light-shielding strips 1081 are parallel to each other, which may avoid the reflection occurring in the same direction under the influence of the light environment.

For example, the two light-shielding strips 1081 located in the same opening K are not parallel to each other, which may reduce the reflection at a side viewing angle to a certain extent.

It should be noted that directions of at least two light-shielding strips 1081 arranged in the same opening K are not limited, and directions of at least two light-shielding strips 1081 in different openings K are also not limited, which may better avoid the reflection phenomenon.

In some embodiments, with continued reference to FIGS. 16 and 17, the light-shielding layer 108 includes at least two light-shielding strips 1081; widths of the at least two light-shielding strips 1081 are all a first width W1; and a distance d1 between two adjacent light-shielding strips 1081, a distance d2 between a light-shielding strip 1081 close to a first border J1 of the opening K and the first border of the opening K, and a distance d3 between a light-shielding strip 1081 close to a second border of the opening K and the second border J2 of the opening K are all a first distance S.

For example, referring to FIG. 16, the light-shielding layer 108 includes two light-shielding strips 1081 that are parallel to each other, and each light-shielding strip 1081 is parallel to the first border J1 and the second border J2 of the opening K. The two light-shielding strips 1081 are arranged in the opening K at equal intervals. That is to say, the distance d1 between two adjacent light-shielding strips 1081, the distance d2 between the light-shielding strip 1081 close to the first border J1 of the opening K and the first border of the opening K, and the distance d3 between the light-shielding strip 1081 close to the second border of the opening K and the second border J2 of the opening K are all the first distance S (that is, d1=d2=d3=S), and the two light-shielding strips 1081 evenly divide the opening K into three portions.

For example, referring to FIG. 17, the light-shielding layer 108 includes two light-shielding strips 1081 that are parallel to each other, and each light-shielding strip 1081 is not parallel to the first border J1 and the second border J2 of the opening K. The two light-shielding strips 1081 are arranged in the opening K at equal intervals. That is to say, the distance d1 between two adjacent light-shielding strips 1081, the maximum distance d2 between the light-shielding strip 1081 close to the first border J1 of the opening K and the first border J1 of the opening K, and the maximum distance d3 between the light-shielding strip 1081 close to the second border of the opening K and the second border J2 of the opening K are all the first distance S (that is, d1=d2=d3=S), and the two light-shielding strips 1081 divide the opening K into three portions.

In some embodiments, with continued reference to FIGS. 16 and 17, the first width W1 is in a range of 8 μm to 10 μm, and the first distance S is in a range of 8 μm to 10 μm.

For example, the first width W1 is set to be 8 μm, 9 μm or 10 μm, and the first distance S is set to be 8 μm, 9 μm or 10 μm. That is, W1 and S1 are equal.

In some embodiments, the plurality of openings K include at least one dummy opening, and the dummy opening(s) expose at least one dummy transistor 13 adjacent to the light leakage transistors 12 among the plurality of dummy transistors 13.

For example, referring to FIGS. 10B, 10C, 11B, 11C, 12B and 12C, after the corresponding welding position is welded by the laser, the dummy transistor 13 and the light leakage transistor 12 can receive the same signal; and in this case, the light-shielding layer 108 above the dummy transistor 13 does not completely shield the dummy transistor 13, but a plurality of dummy openings are provided in the light-shielding layer 108. Each dummy opening exposes a dummy transistor 13 that is adjacent to the light leakage transistor 12 and receives the same signal as the light leakage transistor 12 among the plurality of dummy transistors 13. As a result, it ensures that each dummy transistor 13 can receive sufficient ambient light, so that the dimming chip can be more accurate during the adjustment process.

In some embodiments, the transistors included in the light-sensing unit 10 are oxide transistors.

For example, the oxide transistor can be a P-type transistor or an N-type transistor. The oxide transistor is used because the current generated by the oxide transistor is greater than the current generated by an amorphous silicon transistor, which is beneficial to detection of light-sensing signals, and the oxide transistor has a strong charge retention capability and good stability.

The transistors used in the embodiments of the present disclosure may be thin film transistors, field effect transistors or other devices with the same characteristics. In the embodiments, the coupling modes of the drain and source of each transistor can be interchanged, and therefore, there is actually no difference between the drain and source of each transistor in the embodiments of the present disclosure. Here, just to distinguish the two electrodes of the transistor except the control electrode (i.e., the gate), one of the electrodes is referred to as the drain and the other is referred to as the source. The thin film transistor used in the embodiments of the present disclosure may be an N-type transistor or a P-type transistor. In the embodiments of the present disclosure, when an N-type thin film transistor is used, the first electrode thereof may be a drain, and the second electrode thereof may be a source. When the description is made by taking an example where the thin film transistor is an N-type transistor, that is, when the signal of the control electrode is at a high level, the thin film transistor is turned on. It can be known that when a P-type transistor is used, the timing variation of the driving signal needs to be adjusted accordingly. The specific details are not described here, but should also be within the scope of protection of the present invention.

As shown in FIG. 18, some embodiments of the present disclosure further provide a display apparatus 1000, which includes the display panel 100 as described in any one of the above embodiments, a backlight module 200, and a dimming chip 300. The backlight module 200 is disposed on a side of the display panel 100.

For example, referring to FIG. 18, the display panel 100 is stacked on a light-exit side of the backlight module 200.

In some embodiments, referring to FIG. 18, the dimming chip 300 is electrically connected to the display panel 100 and the backlight module 200. The dimming chip 300 is configured to receive a first current generated by the light-shielding unit and a second current generated by the light leakage unit, and adjust the brightness of light exiting from the backlight module 200 according to the first current and the second current.

For example, referring to FIG. 18, the display apparatus 1000 further includes a flexible circuit board 400 disposed on a side of the display panel 100 and the backlight module 200. The flexible circuit board 400 is electrically connected to the display panel 100 and the backlight module 200. Specifically, an end of the flexible circuit board 400 is electrically connected to a plurality of bonding electrodes located in the bonding region, and the other end of the flexible circuit board 400 is electrically connected to the dimming chip 300. The flexible circuit board 400 is configured to transmit the signals from the dimming chip 300 to the plurality of bonding electrodes.

For example, the first current is a reference current, and the second current is a light-sensing current. The dimming chip can receive and compare the first current and the second current, convert the first current and the second current into an analog signal difference, and output a dimming signal to the backlight module 200, so as to control the brightness of light exiting from the backlight module 200. Thus, the backlight brightness is adjusted as the ambient light changes, thereby improving the display effect on a basis of reducing power consumption.

For example, the display apparatus 1000 is a liquid crystal display (LCD), such as an ADS (advanced super dimension switch) liquid crystal display. The display apparatus provided in the embodiments may also be a TN (twisted nematic) liquid crystal display, an MVA (multi-domain vertical alignment) liquid crystal display, a PVA (patterned vertical alignment) liquid crystal display, an IPS (In-plane switching) liquid crystal display, an FFS (fringe field switching) liquid crystal display or an ADS liquid crystal display.

For example, the display panel is a liquid crystal display panel. The liquid crystal display panel may include an array substrate and a color filter substrate that are assembled, and a liquid crystal layer is provided between the array substrate and the color filter substrate. The liquid crystal layer includes liquid crystal molecules. The array substrate includes pixel electrodes and driving circuits, and the color filter substrate includes a common electrode. The pixel electrode and the common electrode are opposite to form a capacitor. An electric field is formed between the pixel electrode and the common electrode under the control of the driving circuit, and the liquid crystal molecules can be deflected in the electric field. Specifically, each driving circuit corresponds to a pixel point and is used to control display of the pixel point (whether the pixel point emits light, and the brightness of the light). The driving circuit can control the intensity of the electric field formed between the pixel electrode and the common electrode, thereby controlling deflection angles of the liquid crystal molecules between the pixel electrode and the common electrode, and changing the transmittance of the pixel point. The array substrate and the color filter substrate are sealed in their peripheral regions by the frame sealant. A light-shielding layer is also included, which is on the array substrate and located between the array substrate and the frame sealant, and the light-shielding layer completely covers peripheral circuits in the array substrate and located outside the display region.

For example, a material of the light-shielding layer is preferably an opaque metal material such as molybdenum (Mo), copper (Cu) or aluminum (Al), or an opaque resin material such as a black matrix (BM) material for manufacturing the color filter substrate (CF) or another opaque color-resist resin material.

For example, the display apparatus 1000 may be any apparatus that displays images whether in motion (e.g., videos) or stationary (e.g., static images), and whether textual or graphical. More specifically, it is expected that the embodiments may be implemented in or associated with a variety of electronic apparatuses. The variety of electronic apparatuses are (but are not limited to), for example, mobile phones, wireless apparatuses, personal digital assistants (PDAs), hand-held or portable computers, global positioning system (GPS) receivers/navigators, cameras, MP4 video players, video cameras, game consoles, watches, clocks, calculators, television monitors, flat panel displays, computer monitors, car displays (such as odometer displays), navigators, augmented reality (AR) devices, virtual reality (VR) devices, cockpit controllers and/or displays, camera view displays (such as rear view camera displays in vehicles), electronic photos, electronic billboards or indicators, projectors, building structures, packaging and aesthetic structures (such as a display for an image of a piece of jewelry), etc.

The specific form of the display apparatus 1000 is not particularly limited in the embodiments of the present disclosure. Since the display apparatus 1000 adopts the display panel 100 provided in the above embodiments, the display apparatus 1000 provided in the embodiments of the present disclosure has all the beneficial effects achieved by the display panel 100 provided in any one of the above embodiments, which will not be repeated here.

The foregoing descriptions are merely specific implementations of the present disclosure, but the protection scope of the present disclosure is not limited thereto, any changes or replacements that a person skilled in the art could conceive of within the technical scope of the present disclosure shall be included in the protection scope of the present disclosure. Therefore, the protection scope of the present disclosure should be determined by the protection scope of the claims.

1. A display panel, comprising a display region and a peripheral region surrounding the display region, wherein the peripheral region includes a first region, a second region, a third region and a fourth region, the first region and the second region are located on both sides of the display region along a first direction, and the third region and the fourth region are located on both sides of the display region along a second direction; the first direction is perpendicular to the second direction; and the second region includes a bonding region, wherein
the display panel comprises:
a light-sensing unit disposed in the peripheral region of the display panel, wherein the light-sensing unit includes a light-shielding unit and a light leakage unit; the light-shielding unit includes a plurality of light-shielding transistors, and the light leakage unit includes a plurality of light leakage transistors; and the light-sensing unit is arranged in at least one of the first region, the second region, the third region and the fourth region; and
a plurality of bonding electrodes disposed in the bonding region of the display panel, wherein the plurality of bonding electrodes are configured to be connected to a dimming chip, and the plurality of bonding electrodes include a first electrode, a second electrode, a third electrode and a fourth electrode, wherein
control electrodes of the plurality of light-shielding transistors are electrically connected in sequence and electrically connected to the first electrode, first electrodes of the plurality of light-shielding transistors are electrically connected in sequence and electrically connected to the second electrode, and second electrodes of the plurality of light-shielding transistors are electrically connected in sequence and electrically connected to the third electrode; control electrodes of the plurality of light leakage transistors are electrically connected in sequence and electrically connected to the first electrode, first electrodes of the plurality of light leakage transistors are electrically connected in sequence and electrically connected to the second electrode, and second electrodes of the plurality of light leakage transistors are electrically connected in sequence and electrically connected to the fourth electrode.

2. The display panel according to claim 1, wherein the light-sensing unit further includes a dummy unit, and the dummy unit includes a plurality of dummy transistors; the plurality of light-shielding transistors are arranged along a same direction, the plurality of light leakage transistors are arranged along a same direction, and at least part of the plurality of dummy transistors are arranged along a same direction;
the at least part of the dummy transistors are arranged along the same direction as the plurality of light-shielding transistors and/or the plurality of light leakage transistors; and
the plurality of bonding electrodes further include a plurality of dummy electrodes, and the plurality of bonding electrodes are arranged at intervals along the second direction.

3. The display panel according to claim 2, wherein the light-sensing unit is located in the second region;
the plurality of light-shielding transistors are arranged along the second direction, the plurality of light leakage transistors are arranged along the second direction, and the plurality of dummy transistors are arranged along the second direction; and
the light-shielding unit, the dummy unit and the light leakage unit are arranged along the second direction, and the dummy unit is located between the light-shielding unit and the light leakage unit.

4. The display panel according to claim 3, wherein the display panel further comprises multiple groups of fan-out wires between the display region and the bonding region, an interval region is provided between any two adjacent groups of fan-out wires in the multiple groups of fan-out wires, and interval regions include a first interval region, a second interval region and a third interval region; the light-shielding unit is located in the first interval region, the light leakage unit is located in the second interval region, and the dummy unit is located in the third interval region; and/or
the first electrode includes a first sub-electrode and a second sub-electrode, and the second electrode includes a third sub-electrode and a fourth sub-electrode; the control electrodes of the plurality of light-shielding transistors are electrically connected in sequence through a first gate line, and the first gate line electrically connected to the first sub-electrode; the first electrodes of the plurality of light-shielding transistors are electrically connected in sequence through a first drain line, and the first drain line is electrically connected to the third sub-electrode; the control electrodes of the plurality of light leakage transistors are electrically connected in sequence through a second gate line, and the second gate line is electrically connected to the second sub-electrode; the first electrodes of the plurality of light leakage transistors are electrically connected in sequence through a second drain line, and the second drain line is electrically connected to the fourth sub-electrode; and/or
control electrodes of the plurality of dummy transistors are electrically connected in sequence through a dummy gate line, and the dummy gate line is electrically connected to a dummy electrode; second electrodes of the plurality of dummy transistors are electrically connected in sequence through a dummy source line, and the dummy source line is electrically connected in a dummy electrode; first electrodes of the plurality of dummy transistors are electrically connected in sequence through a dummy drain line, and the dummy drain line is electrically connected to a dummy electrode.

5. (canceled)

6. (canceled)

7. The display panel according to claim 2, wherein the light-sensing unit is located in the first region;
the plurality of light-shielding transistors are arranged along the second direction, the plurality of light leakage transistors are arranged along the second direction, and the plurality of dummy transistors are arranged along the second direction; and
the light-shielding unit, the dummy unit and the light leakage unit are arranged along the second direction, and the dummy unit is located between the light-shielding unit and the light leakage unit.

8. The display panel according to claim 7, wherein the control electrodes of the plurality of light-shielding transistors and the control electrodes of the plurality of light leakage transistors are electrically connected in sequence through a gate signal line, and the gate signal line is electrically connected to the first electrode; the first electrodes of the plurality of light-shielding transistors and the first electrodes of the plurality of light leakage transistors are electrically connected in sequence through a drain signal line, and the drain signal line is electrically connected to the second electrodes; and/or
control electrodes of the plurality of dummy transistors are electrically connected in sequence, and first electrodes or second electrodes of the plurality of dummy transistors are electrically connected in sequence.

9. (canceled)

10. The display panel according to claim 2, wherein the light-shielding unit is located in the third region, and the light leakage unit is located in the fourth region;
the plurality of dummy transistors in the dummy unit include a plurality of first dummy transistors and a plurality of second dummy transistors, the plurality of first dummy transistors are located in the third region, and the plurality of second dummy transistors are located in the fourth region;
the plurality of light-shielding transistors are arranged along the first direction, the plurality of light leakage transistors are arranged along the first direction, the plurality of first dummy transistors are arranged along the first direction, and the plurality of second dummy transistors are arranged along the first direction; and
the light-shielding unit and the plurality of first dummy transistors are arranged along the first direction, and the light leakage unit and the plurality of second dummy transistors are arranged along the first direction.

11. The display panel according to claim 10, wherein
the first electrode includes a first sub-electrode and a second sub-electrode, and the second electrode includes a third sub-electrode and a fourth sub-electrode; and the control electrodes of the plurality of light-shielding transistors are electrically connected in sequence through a first gate line, and the first gate line is electrically connected to the first sub-electrode; the first electrodes of the plurality of light-shielding transistors are electrically connected in sequence through a first drain line, and the first drain line is electrically connected to the third sub-electrode; the control electrodes of the plurality of light leakage transistors are electrically connected in sequence through a second gate line, and the second gate line is electrically connected to the second sub-electrode; the first electrodes of the plurality of light leakage transistors are electrically connected in sequence through a second drain line, and the second drain line is electrically connected to the fourth sub-electrode; and/or
control electrodes of the plurality of first dummy transistors are electrically connected in sequence, second electrodes of the plurality of first dummy transistors are electrically connected in sequence, and first electrodes of the plurality of first dummy transistors are electrically connected in sequence; and control electrodes of the plurality of second dummy transistors are electrically connected in sequence, second electrodes of the plurality of second dummy transistors are electrically connected in sequence, and first electrodes of the plurality of second dummy transistors are electrically connected in sequence; and/or
the plurality of first dummy transistors are away from the plurality of bonding electrodes relative to the plurality of light-shielding transistors, and the plurality of second dummy transistors are away from the plurality of bonding electrodes relative to the plurality of light leakage transistors.

12. (canceled)

13. (canceled)

14. The display panel according to claim 1, wherein the second electrodes of the plurality of light-shielding transistors are all electrically connected to a first source line, there is at least one first cutting position on the first source line, and a first cutting position is located between second electrodes of any two adjacent light-shielding transistors; and/or
the second electrodes of the plurality of light leakage transistors are all electrically connected to a second source line, there is at least one second cutting position on the second source line, and a second cutting position is located between second electrodes of any two adjacent light leakage transistors.

15. The display panel according to claim 14, wherein the light-sensing unit is located in the first region; the light-sensing unit further includes a dummy unit, and the dummy unit includes a plurality of dummy transistors;
control electrodes of the plurality of dummy transistors are electrically connected to the control electrodes of the plurality of light-shielding transistors and the control electrodes of the plurality of light leakage transistors; first electrodes of the plurality of dummy transistors are electrically connected in sequence, and are electrically connected to the first electrodes of the plurality of light-shielding transistors and the first electrodes of the plurality of light leakage transistors; second electrodes of the plurality of dummy transistors are all electrically connected to a dummy source line; and
there is a first welding position between the first source line and the dummy source line, and the first source line and the dummy source line are enabled to be welded at the first welding position; and/or there is a second welding position between the second source line and the dummy source line, and the second source line and the dummy source line are enabled to be electrically connected at the second welding position under an action of external force.

16. The display panel according to claim 15, wherein the dummy source line includes at least two dummy source sub-lines that are disconnected, and each dummy source sub-line is electrically connected to a second electrode of at least one dummy transistor in the plurality of dummy transistors; there is a third welding position between two adjacent dummy source sub-lines, and the two adjacent dummy source sub-lines are enabled to be welded at the third welding position.

17. The display panel according to claim 14, wherein the light-shielding unit is located in the third region, and the light leakage unit is located in the fourth region; the light-sensing unit further includes a dummy unit, and the dummy unit includes a plurality of dummy transistors; the plurality of dummy transistors include a plurality of first dummy transistors and a plurality of second dummy transistors, the plurality of first dummy transistors are located in the third region, and the plurality of second transistors are located in the fourth region;
control electrodes of the plurality of first dummy transistors and the control electrodes of the plurality of light-shielding transistors are electrically connected, and first electrodes of the plurality of first dummy transistors and the first electrodes of the plurality of light-shielding transistors are electrically connected; second electrodes of the plurality of first dummy transistors are all electrically connected to a light-shielding dummy source line; there is a fourth welding position between the first source line and the light-shielding dummy source line, and the first source line and the light-shielding dummy source line are enabled to be welded at the fourth welding position; and/or
control electrodes of the plurality of second dummy transistors and the control electrodes of the plurality of light leakage transistors are electrically connected, and first electrodes of the plurality of second dummy transistors and the first electrodes of the plurality of light leakage transistors are electrically connected; second electrodes of the plurality of second dummy transistors are all electrically connected to a light leakage dummy source line; there is a fifth welding position between the second source line and the light leakage dummy source line, and the second source line and the light leakage dummy source line are enabled to be welded at the fifth welding position.

18. The display panel according to claim 17, wherein the light-shielding dummy source line includes at least two light-shielding dummy source sub-lines that are disconnected, and each light-shielding dummy source sub-line is electrically connected to at least one first dummy transistor; there is a sixth welding position between two adjacent light-shielding dummy source sub-lines, and the two adjacent light-shielding dummy source sub-lines are enabled to be welded at the sixth welding position; and/or
the light leakage dummy source line includes at least two light leakage dummy source sub-lines that are disconnected, and each light leakage dummy source sub-line is electrically connected to at least one second dummy transistor; there is a seventh welding position between two adjacent light leakage dummy source sub-lines, and the two adjacent light leakage dummy source sub-lines are enabled to be welded at the seventh welding position.

19. The display panel according to claim 15, wherein the display panel further comprises:
a base substrate;
a gate layer disposed on the base substrate, wherein the gate layer includes a first connection line;
an insulating layer disposed on a side of the gate layer away from the base substrate;
an active layer disposed on a side of the insulating layer away from the base substrate;
a metal layer disposed on a side of the active layer away from the base substrate, wherein the metal layer includes a plurality of signal lines, and the plurality of signal lines include: the first source line, the second source line, the dummy source line, a light-shielding dummy source line, and a light leakage dummy source line;
a passivation layer disposed on a side of the metal layer away from the base substrate; and
a connection layer disposed on a side of the passivation layer away from the base substrate, wherein the connection layer includes a second connection line;
wherein two signal lines that need to be welded are a first signal line and a second signal line; the second connection line is electrically connected to the first signal line through a first via hole penetrating through the passivation layer, and the second connection line is electrically connected to the first connection line through a second via hole penetrating through the passivation layer and the insulating layer; and the first connection line at least partially overlaps with the second signal line, and an overlapping position of the two is a welding position; and
the welding position includes the first welding position, the second welding position, a third welding position, a fourth welding position, a fifth welding position, a sixth welding position, or a seventh welding position.

20. The display panel according to claim 1, wherein
the display panel comprises a base substrate, and further comprises a light-shielding layer disposed on a side of the light-sensing unit away from the base substrate; and
the light-shielding layer is provided therein with a plurality of openings that are arranged at intervals, and each of the plurality of openings exposes a light leakage transistor in the plurality of light leakage transistors.

21. The display panel according to claim 20, wherein the light leakage transistor includes an active layer pattern, the active layer pattern includes a channel portion, and an orthographic projection of the channel portion on the base substrate is located in a middle position of an orthographic projection of the opening on the base substrate.

22. The display panel according to claim 21, wherein in a third direction, a distance between a border of the orthographic projection of the channel portion and a border, on a same side as the border of the orthographic projection of the channel portion, of the orthographic projection of the opening is a first distance; in a fourth direction, a distance between a border of the orthographic projection of the channel portion and a border, on a same side as the border of the orthographic projection of the channel portion, of the orthographic projection of the opening is a second distance; the fourth direction is a direction pointing from a second electrode to a first electrode of the light leakage transistor, and the third direction is perpendicular to the fourth direction.

23. The display panel according to claim 21, wherein the light-shielding layer further includes at least one light-shielding strip disposed in the opening, and the at least one light-shielding strip at least partially overlaps with a second electrode and a first electrode of the light leakage transistor; or
the light-shielding layer further includes at least two light-shielding strips, the at least two light-shielding strips at least partially overlap with a second electrode and a first electrode of the light leakage transistor, and the at least two light-shielding strips are arranged in parallel; and
widths of the at least two light-shielding strips are all a first width; and a distance between two adjacent light-shielding strips, a distance between a light-shielding strip close to a first border of the opening and the first border of the opening, and a distance between a light-shielding strip close to a second border of the opening and the second border of the opening are all a first distance, wherein
the first border and the second border opposite borders of the opening.

24. (canceled)

25. (canceled)

26. The display panel according to claim 20, wherein the plurality of openings include at least one dummy opening, and the at least one dummy opening exposes at least one dummy transistor, adjacent to the light leakage transistor, among the plurality of dummy transistors.

27. (canceled)

28. A display apparatus, comprising:
the display panel according to claim 1;
a backlight module disposed on a side of the display panel; and
a dimming chip electrically connected to the display panel and the backlight module, wherein the dimming chip is configured to receive a first current generated by the light-shielding unit and a second current generated by the light leakage unit, and adjust brightness of light exiting from the backlight module according to the first current and the second current.
